(19) United States
(12) Patent Application Publication
(10) Pub. No.: US 2022/0147908 A1
(43) Pub. Date: May 12, 2022

(54) INTELLIGENT LOGISTICS WEB AND APP IMPROVEMENTS

(71) Applicant: United Parcel Service of America, Inc., Atlanta, GA (US)

(72) Inventor: Bryan Yag, Atlanta, GA (US)

(21) Appl. No.: 17/092,419

(22) Filed: Nov. 9, 2020

(51) Int. Cl. G06Q 10/08; G06N 20/00; G06Q 30/02

(52) U.S. Cl. CPC G06Q 10/083; G06Q 30/0201; G06N 20/00

(57) ABSTRACT

Profile data indicative of one or more attributes associated with one or more users is received. The profile data is stored in computer memory. Preferences are learned, via a machine learning model, based on the profile data. An indication of a user request associated with a user purchasing a first item is received. The user request is issued at a web page or app page of a computing device. In response to the receiving of the user request and based at least in part on the learning, one or more shipping options to ship the first item is caused to be presented at the web page or app page of the computing device.

### BACKGROUND

After launching a web browser or other client application, a user typically either manually enters in a Uniform Resource Locator (URL) or provides search engine terms for each information need they have. Each individual set of information is typically rendered to the user via a single graphical user interface (GUI) or search result page. The user can also manually download or launch an application for each need they have. Users often need to resolve multiple information-based matters simultaneously or within a certain time period, which results in repetitive browser queries, web page clicks, or application downloads. For example, a user may issue a first query that returns an electronic marketplace web application page and the user may desire to purchase a first item. In order to present shipping options to ship the first item that benefits a logistics entity or in order for the user to see what her friends are buying, the user may have to issue respective additional queries that returns a logistics application page and a social media application page. These repetitive inputs result in increased computing resource consumption, among other things. Further, the functionality of existing electronic marketplace applications, online retailer applications, logistics applications, and corresponding user interfaces are limited.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter. Further, alternative or additional embodiments exist other than those described in this summary section.

Some embodiments are directed to a computer-implemented method that comprises the following operations. Profile data indicative of one or more attributes associated with one or more users is received. The profile data is stored in computer memory. Preferences are learned, via a machine learning model, based on the profile data. An indication of a user request associated with a user purchasing a first item is received. The user request is issued at a web page or app page of a computing device. In response to the receiving of the user request and based at least in part on the learning, one or more shipping options to ship the first item are caused to be presented at the web page or app page of the computer device.

Some embodiments are directed a system that includes one or more processors and one or more computer storage media storing computer-useable instructions that, when used by the one or more processors, causes the one or more processors to perform a method. In some aspects, the method comprises the following operations. User input that indicates one or more shipment selections made by one or more users for a plurality of shipments is received. The user input is stored in computer memory. Preferences are learned, via a machine learning model, based on the user input. Based at least in part on the learning, a first option to ship a first item or a second option to earn one or more incentives for a particular user is caused to be presented at a web page or app page of the computer device.

Some embodiments are directed to a computer storage media having computer-executable instructions embodied thereon that, when executed, by a processor, causes the processor to perform a method. In some aspects, the method includes the following operations. Shipping data associated with historical shipments of one or more users and a logistics entity is received. The shipping data is stored in computer memory. Preferences are learned, via a machine learning model, based on the shipping data. Based at least in part on the learning, a first option to ship an item is caused to be presented at a web page or app page of a computing device,

### BRIEF DESCRIPTION OF THE DRAWINGS

Having thus described the disclosure in general terms, reference will now be made to the accompanying drawings, which are not necessarily drawn to scale, and wherein:

FIG. 1 is a schematic diagram of an example computing environment in which aspects of the present disclosure are employed in, according to some embodiments.

FIG. 2 is a schematic diagram of one or more logistics server(s), one or more merchant servers, and/or one or more third party servers in which aspects of the present disclosure are employed in, according to some embodiments.

FIG. 3 is a schematic diagram of a computing entity in which aspects of the present disclosure are employed in, according to some embodiments.

FIG. 4 is a block diagram of an example system, in which aspects of the present disclosure are employed in, according to some embodiments.

FIG. 5 is a block diagram of an example system, in which aspects of the present disclosure are employed in, according to some embodiments.

FIG. 6 is a block diagram of an example system, in which aspects of the present disclosure are employed in, according to some embodiments.

FIG. 7 is a block diagram of an example system, in which aspects of the present disclosure are employed in, according to some embodiments.

FIG. 8 is an example screenshot illustrating merchant checkout functionality that is integrated with logistics functionality, according to some embodiments.

FIG. 9 is an example screenshot of logistics-based checkout functionality, according to some embodiments.

FIG. 10 is a diagram of an example screenshot of a notification, according to some embodiments.

FIG. 11 is a diagram of an example screenshot of revised logistics checkout functionality, according to some embodiments.

FIG. 12 is a block diagram of an example system, in which aspects of the present disclosure are employed in, according to some embodiments.

FIG. 13 is an example screenshot of a user interface dashboard illustrating functionality integrated with one or more third party servers, according to some embodiments.

FIG. 14 is an example screenshot of a user interface illustrating purchase history of a user and associated shipping functionality, according to some embodiments.

FIG. 15 is an example screenshot of a user interface illustrating various incentives offered for recently purchased products, according to some embodiments.

FIG. 16 is an example screenshot of a user interface indicating an item that the user is reselling, according to some embodiments.

FIG. 17 is an example screenshot indicating incentives that are offered based on the user complying with shipment options, according to some embodiments.

FIG. 18 is a flow diagram of an example process for learning preferences based on shipping data, according to some embodiments.

FIG. 19 is a flow diagram of an example process for executing a user request to purchase an item, according to some embodiments.

FIG. 20 is a flow diagram of an example process for generating a single app page or web page of a user interface that includes information from various remote resources, according to some embodiments.

### DETAILED DESCRIPTION OF THE INVENTION

The present disclosure will now be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. Like numbers refer to like elements throughout.

### I. Overview

As indicated above, existing logistics applications, electronic marketplace applications, online retailer applications, and application technologies in general have limited functionality. For instance, although typical retailer or electronic marketplace web applications have a checkout functionality that allows users to place an item in a holding place for purchase, they employ static and limited shipping functionality. For example, typical checkout basket functionality only allows users to select from very limited shipping options (e.g., choosing the day of shipment) that may only benefit or be a part of an electronic marketplace (and not a logistics or other entity). In another example, existing electronic marketplace or online retailer applications do not adequately integrate information from other remote resources, such as social media services and logistics services. In yet another example, existing logistics applications do not include purchasing functionality.

The limited functionality of these applications also includes limited user interface functionality. For instance, existing electronic marketplace applications and online retailer applications fail to adequately link logistics or other third party (e.g., social media services) functionality at the front end while retaining the same look and feel that is seamless for user navigation. Further, certain existing user interface technologies also require users to drill down several layers to obtain relevant information. This may make it arduous and slower for a user to navigate through the user interface to obtain relevant information. Consequently, using these interfaces may be costly for users.

Various embodiments of the present disclosure improve these technologies because they include new functionality that no electronic marketplace applications, online retailer applications, logistics applications, or apps perform. For example, some embodiments integrate logistics application functionality with electronic marketplace/retailer applications, and/or third part functionality via one or more application programming interfaces such that users can select from a wide variety of shipping options that are controlled by or beneficial to logistics entities, electronic marketplace/retailer entities, and/or third party entities. For example, using an electronic marketplace web application, a user may have selected to ship a first item on a first day to a first destination address. However, a logistics entity may have various shipments scheduled for a second day later than the first day, all of which are in the same area as the first destination. Accordingly, particular embodiments can use logistics APIs or other integrated functionality to incentivize the user to arrange for the shipment of the first item to the second day to synchronize delivery such that the first item and the second item are delivered together or otherwise change the delivery location, which would be beneficial for the logistics entity.

Some embodiments improve these technologies because they can learn, via one or more machine learning models, different historical shipping user selections (e.g., service level shipping speed) and/or profile information (e.g., the zip code of the user, day of the week, holiday season) to suggest shipping options of items for users. For example, a user may have a history of shipping items on a first day of the month every month to a first access point (as opposed to the user's home address). Accordingly, some embodiments learn this pattern and suggest the first day of the month to ship an item on at the first access point. In another example, a machine learning model may predict a certain high quantity of shipments will be scheduled for a first day based on the first day being close to a particular holiday and the previous quantity of shipments made in previous years on the same first day. Accordingly, embodiments can learn this pattern and incentivize users not to ship on this first day.

Some embodiments improve these existing technologies by integrating third party functionality, such as social media services into marketplace applications and/or logistics applications. For example, some embodiments generate electronic marketplace/retailer applications or logistics applications that allow users to view particular events (e.g., birthdays of friends, indications of what their friends are buying, etc.), which are provided via one or more APIs corresponding to third party entities, such as social media services, weather services, map services, bidding services, and the like.

Some embodiments improve these existing technologies because they provide more intuitive and user friendly user interfaces. For example, as discussed above, embodiments can integrate logistics functionality with electronic marketplace/retailer and/or third party functionality. As illustrated and described in more detail below, the look and feel of the originating application can be preserved even though there is integrated functionality from other remote sources. For example, if a user requested to purchase a first item via a checkout basket functionality of an electronic marketplace, embodiments can seamlessly and/or automatically connect, via an API, the user to a logistics entity (e.g., UPS) such that the look and feel appears to indicate that the user is still on the electronic marketplace page, even though logistics entity functionality may be currently running. This helps to provide seamless transition of the checkout functionality for users. In another example, some embodiments include one or more views (e.g., a dashboard or main menu) that are intuitive and easily navigable in that they clearly list or indicate the third party functionality that can be used. For example, some embodiments include a dashboard on an electronic marketplace web application that lists upcoming events (e.g., friend birthdays, friend purchases, upcoming bid dates, UBER ride schedules, etc.), the information of which is derived from third parties. This may increase the user's navigation speed by allowing data to be accessed directly from the dashboard, as opposed to drilling down several layers (or performing multiple queries, clicks, selections, etc.) to get the same information.

Existing technologies also consume an unnecessary quantity of computing resources (e.g., I/O costs, network packet generation costs, throughput, memory consumption, etc.). As described above, users often need to resolve multiple information-based matters simultaneously or within a certain time period, which results in repetitive browser queries, web page clicks, or application downloads. For example, a user may issue a first query that returns an electronic marketplace web application page and the user may desire to purchase a first item. In order to present shipping options to ship the first item that benefits a logistics entity or in order for the user to see what her friends are buying, the user may have to issue respective additional queries that returns a logistics application page and a social media application page. These repetitive inputs result in increased computing resource consumption, such as packet generation costs that adversely affect computer network communications. Each time a user issues a query, for example, the contents or payload of the query is typically supplemented with header information or other metadata within a packet in TCP/IP and other protocol networks. Accordingly, when this functionality is multiplied by all the inputs needed to obtain the desired data, there are throughput and latency costs by repetitively generating this metadata and sending it over a computer network.

In some instances, these repetitive inputs (e.g., repetitive clicks, selections, or queries) increase storage device I/O (e.g., excess physical read/write head movements on non-volatile disk) because each time a user inputs unnecessary information, such as inputting several queries, the computing system often has to reach out to the storage device to perform a read or write operation, which is time consuming, error prone, and can eventually wear on components, such as a read/write head. Further, if users repetitively issue queries, it is expensive because processing queries consume a lot of computing resources. For example, an optimizer engine of a database manager module calculates a query execution plan (e.g., calculates cardinality, selectivity, etc.) each time a query is issued, which requires a database manager to find the least expensive query execution plan to fully execute the query. This decreases throughput and increases network latency, and can waste valuable time. Most database relations contain hundreds if not thousands of records. Repetitively calculating query execution plans on this quantity of rows decreases throughput and increases network latency.

Particular embodiments of the present disclosure improve the functioning of the computer itself in light of these existing technologies because they integrate functionality from different resources, such as electronic marketplace web application servers, online retailer servers, logistics servers, and/or third party servers. As such, the user need not perform repetitive queries, selections, clicks, and the like to obtain information separately from these resources. Accordingly, unlike existing technologies, there are relatively lower packet generation costs across one or more computer networks. Additionally, there are relatively lower I/O costs since query execution plans are generated for fewer queries and/or a read/write head reaches out to storage fewer times.

It is understood that although this overview section describes various improvements to conventional solutions and technologies, these are by way of example only. As such, other improvements are described below or will become evident through description of various embodiments. This overview is provided to introduce a selection of concepts in a simplified form that are further described below in the detailed description. This overview is not intended to: identify key features or essential features of the claimed subject matter, key improvements, nor is it intended to be used in isolation as an aid in determining the scope of the claimed subject matter.

### II. Apparatuses, Methods, and Systems

Embodiments of the present disclosure may be implemented in various ways, including as apparatuses that comprise articles of manufacture. An apparatus may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double information/data rate synchronous dynamic random access memory (DDR SDRAM), double information/data rate type two synchronous dynamic random access memory (DDR2 SDRAM), double information/data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices/entities, computing entities, and/or the like. As such, embodiments of the present disclosure may take the form of an apparatus, system, computing device, computing entity, and/or the like executing instructions stored on a computer-readable storage medium to perform certain steps or operations. However, embodiments of the present disclosure may also take the form of an entirely hardware embodiment performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### III. Exemplary System Architecture

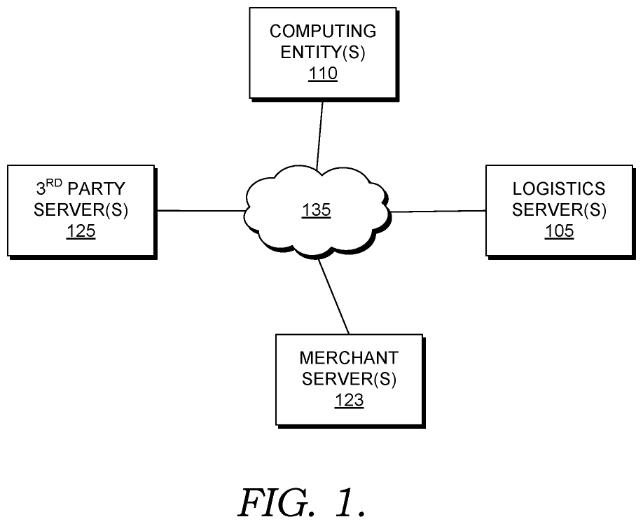

FIG. 1 is a schematic diagram of an example computing environment 100 in which aspects of the present disclosure are employed in, according to some embodiments. As shown in FIG. 1, this particular computing environment 100 includes one or more logistics servers 105 (e.g., a shipping company mainframe, cloud computing nodes, or logistics store desktop) one or more third party servers 125 (e.g., a social media server, a weather server, etc.), one or more merchant servers 12 (e.g., an electronic commerce entity that hosts a marketplace web application or a retailer entity) computing entities 110 (e.g., a mobile device, such as a DIAD or mobile phone), which are communicatively coupled via one or more networks 135. In some embodiments, “communicatively coupled” means that two or more components can perform data transportation between each other via a wired (e.g., ethernet or fiber-optic medium connected in a LAN) or wireless (e.g., IEEE 802.15.4) computer protocol network. Each of these components, entities, devices, systems, and similar words used herein interchangeably may be in direct or indirect communication with, for example, one another over the same or different wired and/or wireless networks. Additionally, while FIG. 1 illustrates the various system entities as separate, standalone entities, the various embodiments are not limited to this particular architecture. In some embodiments, there are more or fewer (or combined) components than illustrated in the environment 100. For example, there need not be a third party server 125 and/or a merchant server 123.

In some embodiments, the computing environment 100 represents a network of components that work together to generate intelligent applications or user interfaces, as described herein. For example, a client application (e.g., a web browser) of one of the mobile computing entities 110 may be running a web application that his hosted by the merchant server(s) 123. The merchant server(s) 123 may receive a request to checkout or purchase an item from the mobile computing entity 110. Responsively, this may trigger a request to the logistics server(s) 105 to present one or more shipping options, as described in more detail herein. The same web application hosted by the one or more merchant servers 124 may contain additional functionality with respect to the third party server(s) 125, as described in more detail herein.

### 1. Exemplary Analysis Computing Entities

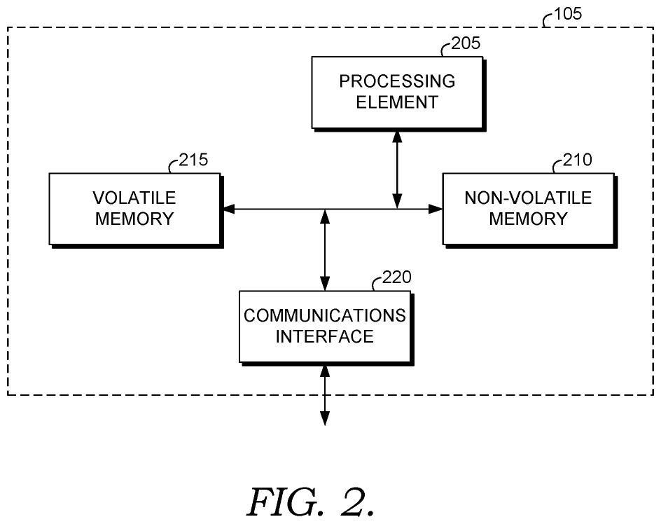

FIG. 2 provides a schematic of a logistics server(s) 105, merchant server(s) 123, and/or the third party server(s) 125, according to particular embodiments of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, consoles input terminals, servers or server networks, blades, gateways, switches, processing devices, processing entities, set-top boxes, relays, routers, network access points, base stations, cloud computing nodes, virtual machines, virtual containers, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In particular embodiments, these functions, operations, and/or processes can be performed on data, content, information/data, and/or similar terms used herein interchangeably.

As indicated, in particular embodiments, the logistics server(s) 105, merchant server(s) 123, and/or the third party server(s) 125 may also include one or more communications interfaces 220 for communicating with various computing entities, such as by communicating data, content, information/data, and/or similar terms used herein interchangeably that can be transmitted, received, operated on, processed, displayed, stored, and/or the like.

As shown in FIG. 2, in particular embodiments, the logistics server(s) 105, merchant server(s) 123, and/or the third party server(s) 125 may include or be in communication with one or more processing elements 205 (also referred to as processors, processing circuitry, and/or similar terms used herein interchangeably) that communicate with other elements within the logistics server(s) 105 via a bus, for example. As will be understood, the processing element 205 may be embodied in a number of different ways. For example, the processing element 205 may be embodied as one or more complex programmable logic devices (CPLDs), microprocessors, multi-core processors, co-processing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In particular embodiments, the logistics server(s) 105, merchant server(s) 123, and/or the third party server(s) 125 may further include or be in communication with non-volatile media (also referred to as non-volatile storage, memory, memory storage, memory circuitry and/or similar terms used herein interchangeably). In particular embodiments, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases (e.g., parcel/item/shipment database), database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or information/data that is stored in a computer-readable storage medium using one or more database models, such as a hierarchical database model, network model, relational model, entity-relationship model, object model, document model, semantic model, graph model, and/or the like.

In particular embodiments, the logistics server(s) 105, merchant server(S) 123, and/or the third party server(s) 125 may further include or be in communication with volatile media (also referred to as volatile storage, memory, memory storage, memory circuitry and/or similar terms used herein interchangeably). In particular embodiments, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the logistics server(s) 105 with the assistance of the processing element 205 and operating system.

As indicated, in particular embodiments, the logistics server(s) 105, merchant server(s), and/or third party server(s) 125 may also include one or more communications interfaces 220 for communicating with various computing entities, such as by communicating information/data, content, information/data, and/or similar terms used herein interchangeably that can be transmitted, received, operated on, processed, displayed, stored, and/or the like. Such communication may be executed using a wired information/data transmission protocol, such as fiber distributed information/data interface (FDDI), digital subscriber line (DSL), Ethernet, asynchronous transfer mode (ATM), frame relay, information/data over cable service interface specification (DOCSIS), or any other wired transmission protocol. Similarly, the logistics server(s) 105 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, long range low power (LoRa), LTE Cat M1, NarrowBand IoT (NB IoT), and/or any other wireless protocol.

Although not shown, the logistics server(s) 105 and/or third party server(s) 125 may include or be in communication with one or more input elements, such as a keyboard input, a mouse input, a touch screen/display input, motion input, movement input, audio input, pointing device input, joystick input, keypad input, and/or the like. The logistics server(s) 105 may also include or be in communication with one or more output elements (not shown), such as audio output, video output, screen/display output, motion output, movement output, and/or the like.

As will be appreciated, one or more of the logistics server(s)'s 105, merchant server(s) 123, and/or third party server(s) 125 components may be located remotely, such as in a distributed system (e.g., a cloud computing system). Additionally or alternatively, the logistics server(s) 105, merchant server(s), and/or the third party server(s) 125 may be represented among a plurality of computing devices. For example, the logistics server(s) 105, merchant server(s) and/or the third party server(s) 125 can be or be included in a cloud computing environment, which includes a network-based, distributed/data processing system that provides one or more cloud computing services. Further, a cloud computing environment can include many computers, hundreds or thousands of them or more, disposed within one or more data centers and configured to share resources over the network(s) 135. Furthermore, one or more of the components may be combined and additional components performing functions described herein may be included in the logistics server(s) 105, merchant server(s) 123, and/or the third party server(s) 125 Thus, the logistics server(s) 105, merchant server(s) 123, and/or third party server(s) 123 can be adapted to accommodate a variety of needs and circumstances. As will be recognized, these architectures and descriptions are provided for exemplary purposes only and are not limiting to the various embodiments.

### 2. Exemplary Computing Entities

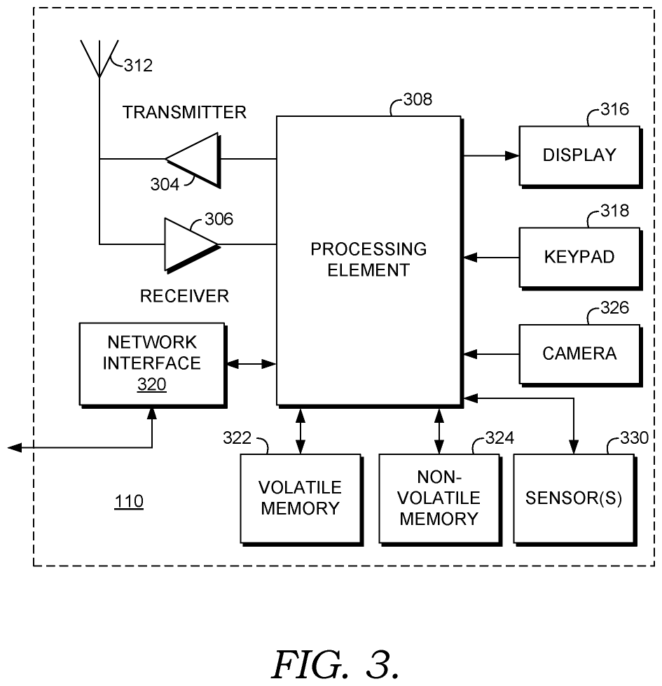

FIG. 3 is a schematic diagram of a computing entity 110 in which aspects of the present disclosure are employed in, according to some embodiments. Computing entities 110 may be configured for displaying or providing one or more portions of a user interface, among other things. In certain embodiments, computing entities 110 may be embodied as handheld computing entities, such as mobile phones, tablets, personal digital assistants, and/or the like, that may be operated at least in part based on user input received from a user via an input mechanism. Moreover, computing entities 110 may be embodied as onboard vehicle computing entities, such as central vehicle electronic control units (ECUs), onboard multimedia system, and/or the like that may be operated at least in part based on user input. Such onboard vehicle computing entities may be configured for autonomous and/or nearly autonomous operation however, as they may be embodied as onboard control systems for autonomous or semi-autonomous vehicles, such as unmanned aerial vehicles (UAVs), robots, and/or the like. As a specific example, computing entities 110 may be utilized as onboard controllers for UAVs configured for picking-up and/or delivering packages to various locations, and accordingly such computing entities 110 may be configured to monitor various inputs (e.g., from various sensors) and generated various outputs. It should be understood that various embodiments of the present disclosure may comprise a plurality of computing entities 110 embodied in one or more forms (e.g., parcel security devices, kiosks, mobile devices, watches, laptops, carrier personnel devices (e.g., Delivery Information Acquisition Devices (DIAD)), etc.)

As will be recognized, a user may be an individual, a family, a company, an organization, an entity, a department within an organization, a representative of an organization and/or person, and/or the like—whether or not associated with a carrier. In particular embodiments, a user may operate a computing entity 110 that may include one or more components that are functionally similar to those of the logistics server(s) 105. FIG. 3 provides an illustrative schematic representative of a computing entity 110 that can be used in conjunction with embodiments of the present disclosure. In general, the terms device, system, computing entity, entity, and/or similar words used herein interchangeably may refer to, for example, one or more: computers, computing entities, desktops, mobile phones, micro-computers (e.g., RASBERY PI), tablets, phablets, notebooks, laptops, distributed systems, vehicle multimedia systems, autonomous vehicle onboard control systems, watches, glasses, key fobs, radio frequency identification (RFID) tags/readers, ear pieces, scanners, imaging devices/cameras (e.g., part of a multi-view image capture system), wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Computing entities 110 can be operated by various parties, including carrier personnel (sorters, loaders, delivery drivers, network administrators, and/or the like). As shown in FIG. 3, the computing entity 110 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, respectively. In some embodiments, the computing entity 110 includes one or more sensors 330 (e.g., a camera with object detection capabilities). The one or more sensors 330 can be one or more of: a pressure sensor, an accelerometer, a gyroscope, a geolocation sensor (e.g., GPS sensor), a radar, a lidar, sonar, ultrasound, an object recognition camera.

The signals provided to and received from the transmitter 304 and the receiver 306, respectively, may include signaling information in accordance with air interface standards of applicable wireless systems. In this regard, the computing entity 110 may be capable of operating with one or more air interface standards, communication protocols, modulation types, and access types. More particularly, the computing entity 110 may operate in accordance with any of a number of wireless communication standards and protocols, such as those described above with regard to the logistics server(s) 105. In a particular embodiment, the computing entity 110 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the computing entity 110 may operate in accordance with multiple wired communication standards and protocols, such as those described above with regard to the logistics server(s) 105/123/125 via a network interface 320.

Via these communication standards and protocols, the computing entity 110 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 110 can also download changes, add-ons, and updates, for instance, to its firmware, software (e.g., including executable instructions, applications, program modules), and operating system.

According to particular embodiments, the computing entity 110 may include location determining aspects, devices, modules, functionalities, and/or similar words used herein interchangeably. For example, the computing entity 110 may include outdoor positioning aspects, such as a location module adapted to acquire, for example, latitude, longitude, altitude, geocode, course, direction, heading, speed, universal time (UTC), date, and/or various other information/data. In particular embodiments, the location module can acquire information/data, sometimes known as ephemeris information/data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This information/data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information can be determined by triangulating the computing entity's 110 position in connection with a variety of other systems, including cellular towers, Wi-Fi access points, and/or the like. Similarly, the computing entity 110 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices/entities (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The computing entity 110 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the computing entity 110 to interact with and/or cause display of information from the logistics server(s) 105 and/or third party server(s) 125, as described herein. The user input interface can comprise any of a number of devices or interfaces allowing the computing entity 110 to receive information/data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the computing entity 110 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

As shown in FIG. 3, the computing entity 110 may also include an camera, imaging device, and/or similar words used herein interchangeably 326 (e.g., still-image camera, video camera, IoT enabled camera, IoT module with a low resolution camera, a wireless enabled MCU, and/or the like) configured to capture images. The computing entity 110 may be configured to capture images via the onboard camera 326, and to store those imaging devices/cameras locally, such as in the volatile memory 322 and/or non-volatile memory 324. As discussed herein, the computing entity 110 may be further configured to match the captured image data with relevant location and/or time information captured via the location determining aspects to provide contextual information/data, such as a time-stamp, date-stamp, location-stamp, and/or the like to the image data reflective of the time, date, and/or location at which the image data was captured via the camera 326. The contextual data may be stored as a portion of the image (such that a visual representation of the image data includes the contextual data) and/or may be stored as metadata (e.g., data that describes other data, such as describing a payload) associated with the image data that may be accessible to various computing entities 110.

The computing entity 110 may include other input mechanisms, such as scanners (e.g., barcode scanners), microphones, accelerometers, RFID readers (or Near-Field Communication (NFC)readers), and/or the like configured to capture and store various information types for the computing entity 110. For example, a scanner may be used to capture parcel/item/shipment information/data from an item indicator disposed on a surface of a shipment or other item. In certain embodiments, the computing entity 110 may be configured to associate any captured input information/data, for example, via the onboard processing element 308. For example, scan data captured via a scanner may be associated with image data captured via the camera 326 such that the scan data is provided as contextual data associated with the image data.

The computing entity 110 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, information/data, applications, programs, program modules, scripts, source code, object code, byte code, compiled code, interpreted code, machine code, executable instructions, and/or the like to implement the functions of the computing entity 110. As indicated, this may include a user application that is resident on the entity or accessible through a browser or other user interface for communicating with the logistics server(s) 105 and/or various other computing entities.

In another embodiment, the computing entity 110 may include one or more components or functionality that are the same or similar to those of the logistics server(s) 105, as described in greater detail above. As will be recognized, these architectures and descriptions are provided for exemplary purposes only and are not limiting to the various embodiments.

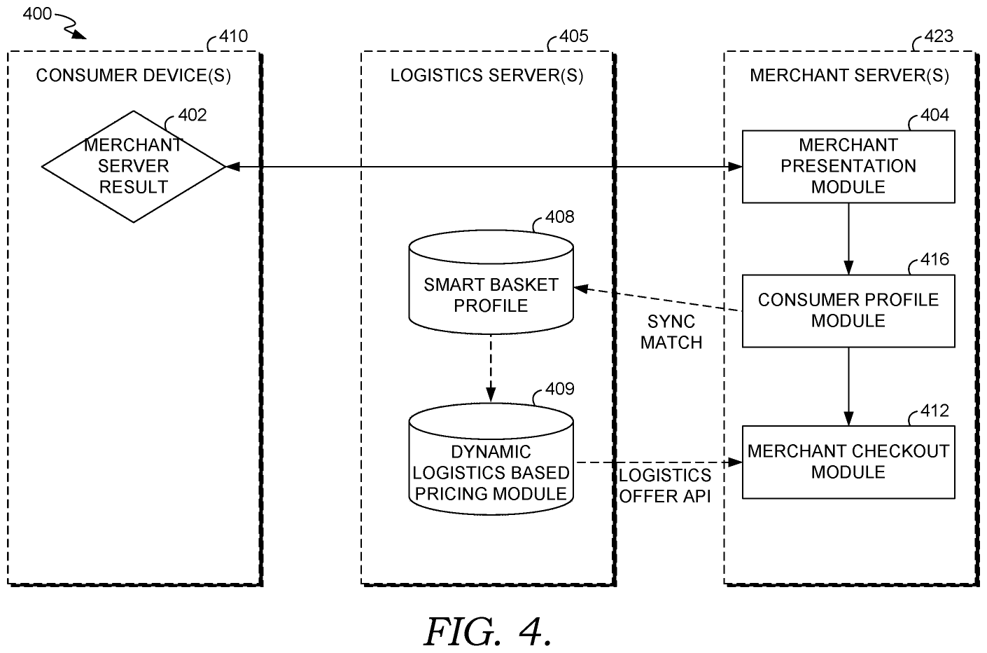

FIG. 4 is a block diagram of an example system 400, in which aspects of the present disclosure are employed in, according to some embodiments. The system 400 illustrates a merchant-driven process where consumers engage in one or more transactions (e.g., request purchase of an item) and check out directly through the merchant server(s) 423 with the logistics server(s) 405 acting in the background to serve personalized offers (e.g., shipping options, incentives, etc.) in the merchant checkout functionality (e.g., a shopping cart function). In some embodiments, the consumer device(s) 410 represents the computing entity 110 and vice versa. Likewise, in some embodiments the logistics server(s) 405 represents the logistics server(s) 105 of FIG. 1 and vice versa. Likewise, in some embodiments, the merchant server(s) 423 represents the merchant server(s) 123 and vice versa.

In various embodiments, the consumer device(s) 410 may have already logged on or otherwise be displaying a view of an application (e.g., a web application) hosted by the one or more merchant servers 123. For example, the one or more merchant server(s) 423 may host an electronic marketplace or retailer application where various items are for sale. The user may be browsing, querying, selecting or otherwise searching for one or more desired items. The consumer device(s) 410 issues a merchant service request 402 to the one or more merchant servers 423 to purchase one or more items in response to a user selection or other input associated with the one or more items. Responsively, the merchant presentation module 404 causes display, to the one or more consumer devices 402, of a user interface or checkout functionality (e.g., a shopping cart) to complete a transaction purchase of the one or more items. Responsively, the merchant presentation module 404 links to or communicates with the consumer profile module 406. The consumer profile module 406 is generally responsible for locating profile data indicative of one or more attributes associated with the user of the consumer device(s) 402 and transmitting, over a computer network and to the logistics server(s) 405 (e.g., via an API) the profile data in order to receive back pricing or shipping information associated with the one or more items requested to be purchased. For example, the consumer profile module 406 can automatically locate the user's name, address, device ID and other identifying information and communicate in the background (i.e., automatically without an explicit user request) to the logistics server(s) 405. The logistics server(s) 105 may then search the smart basket profile 408 to match or search for profile data received from the consumer profile module 406. The smart basket profile 408 is generally responsible for storing specific user information associated with shipping or logistics, such as rewards points accrued by the user of the consumer device(s) 410, consumer shipping patterns learned (e.g., day of shipment pattern learned by a machine learning model). In some embodiments, the requesting user of the consumer device(s) 410 has no existing account with the smart basket profile 408. In some aspects of these embodiments, the logistics server(s) 405 can register users by automatically storing a record of the user that contains all the information gathered by the consumer profile module 406. Alternatively or additionally, the logistics server(s) 405 can register users by causing presentation of a user interface to the consumer device(s) 410 that includes various fields of information for the user to input, such as destination address, billing information, and the like.

In some embodiments, the smart basket profile 408 includes user preferences for specific users. For example, the user preferences can include package delivery preferences (e.g., day of week, parcel size, destination address), contact information, shipping address, credit card/ACH bank payment information, loyalty rewards points, package delivery.

The dynamic logistics based pricing module 409 is generally responsible for generating one or more shipping options and/or pricing information associated with item purchases. The dynamic logistics based pricing module 409 generates specific logistics offers and sends them through a logistics offer API (and over a computer network) to the merchant checkout module 412 based on the specific information stored to the smart basket profile 408. For example, the module 409 may lookup the profile 408 to determine that the user lives at a destination address were multiple other shipments will already be shipped to on date X. Accordingly, the module 409 may generate and present a logistics offer, via the logistics offer API, to the merchant checkout module 419, which provides the user a reduction of a shipping cost of the one or more items for sale at the merchant server(s) 423 if the user selections a shipping option for date X (e.g., in hopes to get the user to consolidate a shipment of the items with other items). As described in more detail herein, the logistics offer can be any suitable offer, such as an offer to change the shipping destination address (e.g., from a home address to a shipping locker), change the shipping date, offer rewards points, etc.

In these merchant-driven embodiments, various incentives and benefits are provided to each entity. For instance, consumers have more control over the purchase of items. They have the ability to change total costs of transactions. Further logistics entities can obtain more volume, data, information (e.g., for retargeting consumers), and can save on shipping costs. Further, merchants can view and have higher conversion rates, increased control over user experiences (or UI features), and increased control over pricing.

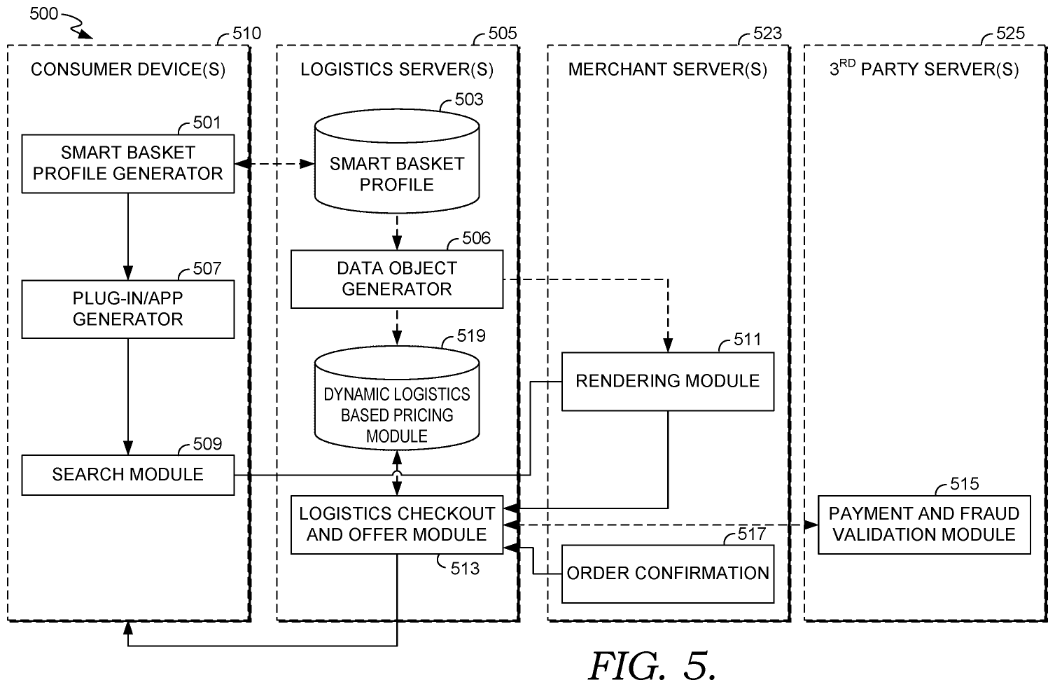

FIG. 5 is a block diagram of an example system 500, in which aspects of the present disclosure are employed in, according to some embodiments. The system 500 illustrates a consumer-driven environment where consumers install an app, extension, or plugin that gives them control over the checkout process and access to logistics operations, including dynamic logistics pricing or other shipping functionality. In some embodiments, the consumer device(s) 510 represents the computing entity 110 and vice versa. Likewise, in some embodiments the logistics server(s) 505 represents the logistics server(s) 105 of FIG. 1 and vice versa. Likewise, in some embodiments, the merchant server(s) 523 represents the merchant server(s) 123 and vice versa. Likewise, in some embodiments, the third party server(s) 525 represent the third party server(s) 125 of FIG. 1 and vice versa.

In various embodiments the one or more consumer devices 510 includes a locally stored app or other application that includes the smart basket profile generator 501, the plug-in/app generator 507, and the search module 509. This application allows users to engage in transactions from the point of view of an app that is controlled mostly by the logistics server(s) 505 and locally stored information. The smart basket profile generator 501 is generally responsible for setting up configuration and/or installation parameters indicative of a smart basket profile 503 obtained from the logistics server(s) 505. In some embodiments the smart basket profile 503 is or includes all of the information as described with respect to the smart basket profile 408 of FIG. 4 and vice versa. The smart basket profile 503 may include credit card information associated with a user of the consumer device(s) 510, logistics information, and the like. For instance “logistics information” can include any information concerning the process of shipping one or more parcels from an origin to a destination that details ordering, purchasing, forwarding, warehousing, etc. (e.g., shipping destination address of user, shipping dimensions of parcels shipped by user, shipping service level used by user, specific shipping instructions (e.g., put shipment in back yard), a list of consignees, assigned drivers for current shipments, incentive points of user, a list of all outbound shipments made by user, and the like.

In various embodiments, responsive to the smart basket profile 503 being queried by the smart basket profile generator 501, the data object generator 506 generates a data object (e.g., a cookie) that stores information about the user of the consumer device(s) 510, such as information in the smart basket profile 503. In some embodiments, in response to the data object generator 506 generating the data object, it is transmitted back to the consumer device(s) 510 such that in response to the search module 509 querying the merchant server(s) 523, the merchant server(s) 523 can read or interrogate the data object for the information in the data object. Alternatively or additionally, in response to the object generator 506 generating the data object, it is transmitted directly to the merchant server(s) 523 such that in response to the search module 509 querying the merchant server(s) 523, the merchant server(s) 523 can match device information (e.g., IP address, device ID, etc.) received from the query with data located in the data object.

In some embodiments, the data object generator 506 passes the data object to the dynamic logistics based pricing module 519. Accordingly, the dynamic logistics based pricing module 519 can generate logistics offers or offer shipping solutions (e.g., an office to synchronize delivery or change delivery locations) based on information contained in the data object. For example, the data object may contain service level data, such as a one-day shipping request by a user. Accordingly, the dynamic logistics based pricing module 519 can incentivize the user to change the service level (e.g., to two-day shipping) in order to synchronize delivery with other shipments based on reducing a cost to ship. In some embodiments, the dynamical logistics based pricing module 519 represents the dynamic logistics based pricing module 409 of FIG. 4, and vice versa.

The plug-in/app generator 507 is generally responsible for causing installation or a download of an application, plug-in, or extension associated with the smart basket profile generator 501 and the search module 509 to the consumer device(s) 510. For example, after configuring the parameters of an app according to the smart basket profile generator 501, the app can be installed (e.g., automatically or in response to a user request). The search module 509 is responsible for connecting or communicating (e.g., via an API over a computer network) to the rendering module 511 of the merchant server(s) 523 so that the rendering module 511 can provide items for sale and associated merchant views, user interfaces, or displays. In this way, the consumer of the consumer device 510 can search for and locate an item he or she wishes to purchase. In response to receiving, from the one or more consumer devices 510, a user selection of one or more items for purchase, the rendering module 511 communicates (e.g., via another API and over a computer network) with the logistics checkout and offer module 513.

The logistics checkout and offer module 513 is generally responsible for generating checkout functionality (e.g., a shopping cart) based on communicating with the dynamic logistics based pricing module 519 and communicating (e.g., via an API over the computer network) with the payment and fraud validation module 515. This checkout functionality is rendered and causes display to the consumer device(s) 510. For example, the logistics checkout and offer module 513 can cause presentation of different shipping options, associated costs, incentives, and the like derived from the dynamic logistics pricing module 519. The payment and fraud validation module 515 is generally responsible for processing transactions (e.g., credit card transactions) and also authenticates or authorizes the user to make a purchase of the requested items for purchase. For example, the payment and fraud validation module 515 can include PAYPAL, GOOGLE PAY, APPLE PAY, a bank account associated with the user of the consumer device(s) 510, and/or any other set of entities that process transactions and verify that users have the funds to complete a transaction

The logistics checkout and offer module 513 may additionally send an order confirmation 517 to the merchant server(s) 523. The order confirmation 517 may include, the item(s) purchased, timestamp of purchase, date of shipment, and/or any other data determined by the dynamic logistics based pricing module 519. In this way, merchants can prepare for or cause shipments of the items or otherwise notify other entities in a supply chain (e.g., manufacturers, distributors, etc.).

The system 500 of FIG. 5 may cause benefits for various entities. For example, consumers have control over purchase via the app, plug-in, or extension and can change costs based on the desired service level. Logistics entities can be guaranteed increased volume and revenue, as well as increased data and information (e.g., for retargeting consumers). Merchants can see increased conversion rates, and the integrated functionality decreases costs and saves on time building platforms from scratch. Rather, APIs can be used to connect to various entities to reduce building costs.

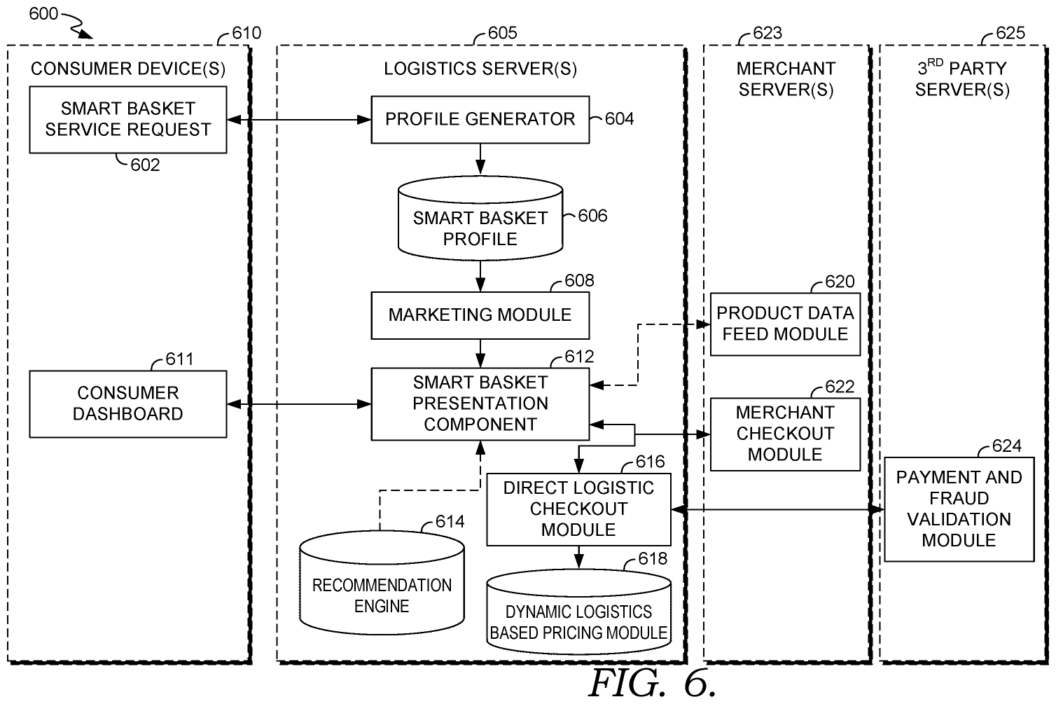

FIG. 6 is a block diagram of an example system 600, in which aspects of the present disclosure are employed in, according to some embodiments. The system 600 illustrates embodiments that are logistics driven in that logistics smart basket platform identifies consumer needs and facilitates transaction either directly or through referrals to merchant sites with logistics as a key component of the value proposition. In some embodiments, the consumer device(s) 610 represent the consumer device(s) 110 of FIG. 1 and vice versa. Likewise, in some embodiments, the logistics server(s) 605 represent the logistics server(s) 105 of FIG. 1 and vice versa. Likewise, in some embodiments, the merchant server(s) 623 represent the merchant server(s) 123 of FIG. 1 and vice versa. Likewise, in some embodiments, the third party server(s) 625 represent the third party server(s) 125 of FIG. 1 and vice versa.

In some embodiments, one or more users of the consumer device(s) 610 query or otherwise enter a URL at a client application (e.g., a web browser), which brings them to a page of a web application hosted by the logistics server(s) 105. Responsively or subsequently, the consumer device(s) 610 send the smart basket service request 602, which is indicative of a request to create or identify profile data for the one or more users. In various embodiments, this occurs automatically without a user request. Alternatively, the profile generator 604 may prompt the user to generate profile information and after this information is generated, it is sent as the smart basket service request 602.

The profile generator 604 is generally responsible for creating or locating the smart basket consumer profile 606 for the one or more users of the consumer device(s) 610. In some embodiments, the smart basket consumer profile 606 represents the smart basket profile 503 of FIG. 5 and/or the smart basket profile 408 of FIG. 4. The marketing module 608 is generally responsible for generating or presenting ads (e.g., retargeting ads) based on information indicated in the smart basket consumer profile 606. For instance, if the smart basket consumer profile 606 indicates that the user has purchases several golf attire items, the marketing module 608 may generate an ad for a golf club to a user interface presented on the consumer dashboard 611 of the consumer device(s) 610.

The smart basket presentation component 612 is generally responsible for the content, metadata, and/or structure (e.g., sitemap) of the website, web application, dashboard, pages, and the like presented to the consumer device(s) 610. The consumer dashboard 611 (e.g., a landing page, home page, etc.) is initially caused to be presented to the consumer device(s) 610 after his or her profile has been generated.

The product data feed module 620 is generally responsible for rending products or items that are for sale at a merchant associated with the merchant server(s) 623. For example, the product data feed module 620 may provide, to the smart basket presentation component 612, a list of items for sale at an electronic marketplace. The merchant checkout module 622 is generally responsible for generating a page that includes merchant checkout functionality. In some embodiments, the merchant checkout module 622 represents the merchant checkout module 412 of FIG. 4 and vice versa. Alternatively or additionally, the smart basket presentation component 612 may utilize the direct logistics checkout module 616 to either present the same page as the merchant checkout module 412 or use a different page altogether.

The direct logistics checkout module 616 is responsive for generating checkout functionality that includes the dynamic logistics based pricing module 618 and is based on information contained in the smart basket consumer profile 606. In some embodiments, the dynamic logistics based pricing module 618 represents the dynamic logistics based pricing module 519 of FIG. 5 and/or the dynamic logistics based pricing module 409 of FIG. 4 and vice versa. In some embodiments, the direct logistics checkout module 616 represents the logistics checkout and offer module 513 of FIG. 5 and vice versa.

The payment and fraud validation module 624 is generally responsible for processing transactions (e.g., credit card transactions) and also authenticates or authorizes the user to make a purchase of the requested items for purchase. In some embodiments, the payment and fraud validation module 624 represents the payment and fraud validation module 515 of FIG. 5 and vice versa.

The recommendation engine 614 is generally responsible for recommending specific items for sale, ads, rewards points, shipping options, and/or the like based on information included in the smart basket consumer profile 606 for specific users of the consumer device(s) 110. For example, the recommendation engine 614 may represent or use one or more machine learning models that learn user preferences based on user input and profile data (e.g., that the user always ships on Monday), and accordingly cause a change made by the dynamics logistics based pricing module 618 of shipping option days, which is then provided to the consumer dashboard 611 or otherwise be provided to the consumer deice(s) 110.

In various instances there are various benefits to the various entities of the system 600. For example, consumers can have increased and consistent user experiences. Consumers can also have control over costs based on desired service level, learning, or other information contained in the smart basket consumer profile 606. Logistics entities can also increase volume and revenue and have almost exclusive control over e-commerce transactions. Further merchants can gain new customers they would have not otherwise had and the integration of the logistics entities and third party APIs can save in time and costs.

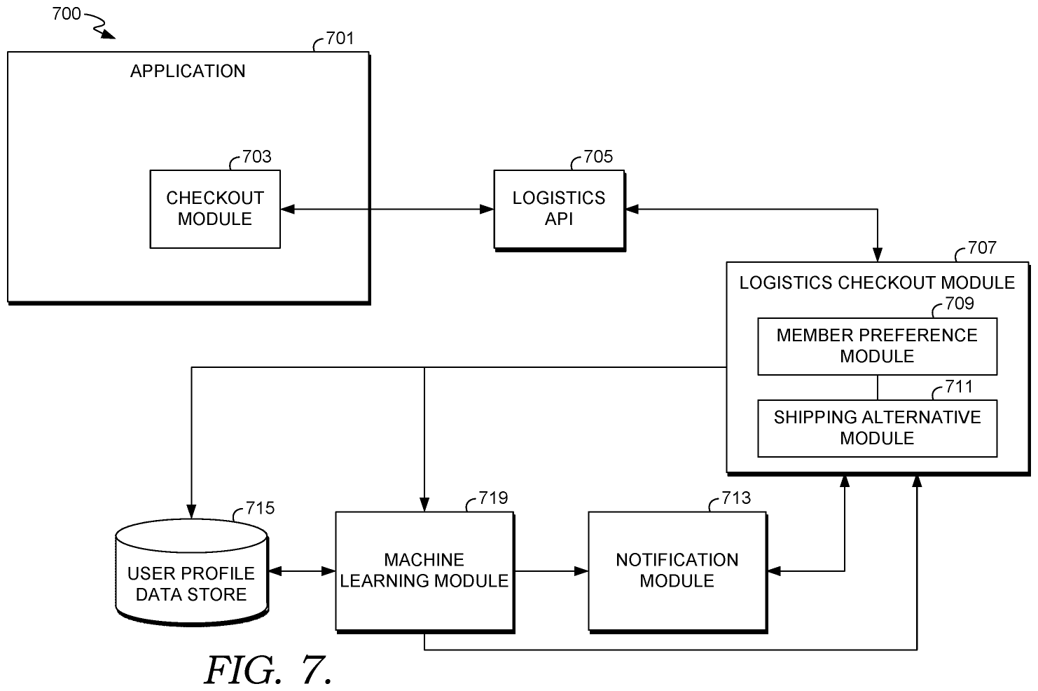

FIG. 7 is a block diagram of an example system 700, in which aspects of the present disclosure are employed in, according to some embodiments. In some embodiments, one or more components of the system 700 are included in any of the systems 400, 500, and/or 600 of FIGS. 4, 5, and 6 described herein. The system 700 is generally responsible for generating one or more preferences or shipping alternatives based at least in part on machine learning functionality.

The application 700 may be any suitable application or component (e.g., a web application, app, plugin, extension) stored to the merchant server(s) 123, the logistics server(S) 105 and/or the third party server(s) 125. The checkout module 701 is generally responsible for at least partially processing consumer transactions and causing presentation of related data in response to receiving user requests. For example, in response to receiving a user request to purchase an item, the checkout module 703 may generate and caused to be displayed a shopping cart page. In some embodiments, the checkout module represents: the merchant checkout module 412 of FIG. 4, and/or the merchant checkout module 622 of FIG. 6.

The logistics API 705 is generally responsible for gathering information obtained from the logistics checkout module 707 to provide to the checkout module 703 so that the checkout module 703 may cause this information (or indications of the information) to be displayed (e.g., to a computing entity 110). The logistics checkout module 707 is generally responsible for generating member preferences and shipping options based on using one or more machine learning models. In some embodiments, the logistics checkout module 707 represents the logistics checkout and offer module 513 and/or the direct logistics checkout module 616 and vice versa.

Specifically, the member preference module 709 is responsible for determining user preferences. User preferences may include any static logistical information about a user or any learned (e.g., by the machine learning model 719) information. For example, the user preferences can include package delivery preferences (e.g., day of week, parcel size, destination address) contact information, shipping address, credit card/ACH bank payment information, loyalty rewards points, package delivery. In some embodiments, the member preference module 709 searches the user profile data store 715, smart basket profile 408 of FIG. 4, smart basket profile 503 of FIG. 5, and/or the smart basket consumer profile 606 of FIG. 6 to obtain the user preferences.

The shipping alternative module 711 is generally responsible for generating and presenting different shipping options or alternatives to users (e.g., based on the member preferences determined by the member preference module 709 and/or the machine learning module 719). Shipping options can include different dates, shipping costs, and/or incentives options that users can select for shipping a selected item(s). For example, the shipping options can include providing a 20 point incentive for changing a shipping address from a home shipping address to an access point. An “access point” as described herein is a contracted or participating retail entity (e.g., a grocery store or gas station) or other entity (e.g., a hotel, a law firm building) that serves as a parcel delivery and/or retrieval location for parcels.

The machine learning module 719 represent or uses one or more machine learning models (e.g., Long Short Term Memory (LSTM), random forest, Siamese Neural Networks (SNN), linear regression, K-means clustering, K-nearest neighbor, support vector machine) using information from the user profile data store 715 and/or the logistics corpus 717. The term “machine learning model” refers to a model that is used for machine learning tasks or operations. In various embodiments, a machine learning model can receive an input (e.g., data from the user profile data store 715), and based on the input identify patterns or associations in order to predict a given output (e.g., classify whether the user prefers to ship on a particular day of the week). Machine learning models can be or include any suitable model, such as one or more: neural networks, word2Vec models, Bayesian networks, Random Forests, Boosted Trees, etc. “Machine learning” as described herein, in particular embodiments, corresponds to algorithms that parse or extract features of historical data (e.g., logistics corpus 717), learn (e.g., via training) about the historical data by making observations, weighting features, and/or identifying patterns in data, and then receive a subsequent input (e.g., a current item purchase request via the checkout module 703) in order to make a determination, prediction, and/or classification of the subsequent input based on the learning without relying on rules-based programming (e.g., conditional statement rules).

The user profile data store 715 is generally responsible for storing any information concerning one or more particular users. For example, the user profile data store 715 may store one or more of the following: days of the week that a user(s) has historically shipped on, access points that the user(s) has historically had shipments picked up from/dropped off to, logistics service level (e.g., overnight shipping, 2-day shipping) that the user(s) has used, time or duration of transit of parcels, whether or not users had signature requirements, number of missed deliveries for one or more users (and/or the time/day of those misses), historical package weight, cube of all shipments of particular user(s), retailer/shipper used when shipping shipments, value or price of goods previously shipped, historical geolocations of users(s) at the time of delivery of shipment(s), industry identifiers (e.g., pharmaceutical, IT, clothing etc.) of items historically purchased, product types (e.g., shoes, glasses, gloves) of items historically purchased, specific items purchased in the parcels, the time of day of purchase and/or deliveries of historical shipments, level or value incentive that users historically have acted on or been given, users' willingness to pay more for shipping costs, the specific weather conditions (e.g., temperature, snowy, icy, sunny, and/or partly cloudy) when one or more shipments were delivered/requested, the zip-code of all users requesting shipments, a history of items that users have purchased, and/or the like.

The machine learning module 719 receives some or all of the information within the user profile data store 715 as inputs and learns one or more patterns associated with the inputs. For example, some embodiments, extract features from each input (e.g., a specific shipment event or set events of a specific user), convert the features to an n-dimensional feature vector and weight the numbers (or nodes) representing the features based on patterns detected (within the same input or other inputs) and then output the feature vectors in feature space to determine classifications and/or predictions. A “weight” in various instances represents the importance or significant of a feature or feature value for classification or prediction. For example, each feature may be associated with an integer or other real number where the higher the real number, the more significant the feature is for its label. In some embodiments, a weight in a neural network or other machine learning application can represent the strength of a connection between nodes or neurons from one layer (an input) to the next layer (an output). A weight of 0 may mean that the input will not change the output, whereas a weight higher than 0 changes the output. The higher the value of the input or the closer the value is to 1, the more the output will change or increase. Likewise, there can be negative weights. Negative weights proportionately reduce the value of the output. For instance, the more the value of the input increases, the more the value of the output decreases. Negative weights may contribute to negative scores, which are described in more detail below. In many instances, only a selected set of features are primarily responsible for a determination of whether a particular input has a certain classification nor prediction.

In various embodiments, the weighting is based on training or analyzing prior inputs. One or more machine learning model (e.g., a deep learning model) can be trained based at least in part on learning weights associated with the extracted features of inputs. For example, using the illustration above, a particular feature may be the day of the week that user has shipped on. These weights can be learned for each shipment input to determine which inputs belongs to certain classifications, such as “early-week shipper” or “weekend shipper.”

In some embodiments, pairs of inputs are run through a deep learning model by comparing the associated features and mapping it in feature space. And based at least in part on the processing, weights associated with the deep learning model can be adjusted to indicate the importance of the extracted featured for prediction or classification. In some embodiments, the adjusting includes changing an embedding in feature space of a feature vector representing the classification. For example, after a first round or set of rounds of training, it may be unknown whether a particular user (having shipments on various days) has a certain particular day-of-the-week classification or prediction. Accordingly, each feature may take on equal weight (or close to equal weight within a threshold, such as a 2% changed weight) such that all of the feature vectors are substantially close or within a distance threshold in feature space. However, after several rounds or epochs of training or any threshold quantity of training, these same feature vectors may adjust or change distances from each other based on the feature value similarity. The more features of two feature vectors that match or are within a threshold value, the closer the two feature vectors are to each other (e.g., in Euclidian distance), whereas when features do not match or are not within a threshold value, the further away the two feature vectors are from each other.

The training may include adjusting weights associated with the deep learning model to indicate the importance of certain features of the set of images for prediction or classification. In some embodiments, the training includes learning an embedding (e.g., a precise coordinate or position) of one or more feature vectors representing the one or more features representing a classification in feature space. Learning an embedding may include learning the distance between two or more feature vectors representing two or more image style features of two or more images based on feature similarity of values between the two or more images and adjusting weights of the deep learning model. For example, as described above, the more that features of two inputs are matching or are within a threshold feature vector value, the closer the two inputs are to each other in feature space, whereas when features do not match or are not within a feature vector value threshold, the further away the two feature vectors are from each other in feature space. Accordingly, in response to various training stages, the strength of connection between nodes or neurons of different layers can be weighted higher or strengthened based on the corresponding learned feature values that are most prominent or important for a particular family or classification. In this way, for example, an entire feature space may include an embedding of vectors or other indications that are all learned or embedded in feature spaced based on learning weights corresponding to different input features such that indications of inputs with important features within a threshold distance of each other in feature space are near each other, whereas indications corresponding to dissimilar inputs with features that are not important are not within a threshold distance of each other in the same feature space, are further away.

Using the illustration above, for example, users whose shipment arrive at the beginning of the week will be classified differently and be associated with a classification that is far in distance with users whose shipments arrive at the end of the week. In this way, when a runtime input comes in from the logistics checkout module 707 (i.e., there has been a current request to purchase an item), that input can be fed directly to the machine learning module 719 as illustrated in FIG. 7 so that the machine learning model can convert the input into a feature vector, and predict that the user's shipment is likely to arrive at the beginning of the week based on other features extracted from the input and similar features of other historical inputs (e.g., the day of the week shipment was requested, the service level used, the city lived in, etc.), indicative of the distance of the feature vector representing the input being close to the “beginning of week” classification.

In some embodiments, the machine learning module 719 uses the prediction made by one or more machine learning models to provide to the notification module 713. The notification module 713 is generally responsible for generating one or more notifications or indications to be sent to one or more user devices (e.g., computing entity 110) based on the learning. For example, if the user profile data store 715 indicates that a user has historically purchased a basketball, basketball shoes, and basketball game tickets (indicative of a “basketball” classification in feature space), the machine learning module 717 may communicate this information or classification to the notification module 713. Responsively, the notification module 713 may cause presentation of an ad for a basketball jersey, basketball shorts, basketball playing cards or anything related to the “basketball” classification in order to incentivize the user to purchase more items.

Alternatively or additionally, the machine learning module can pass along its predictions or classification information to the logistics checkout module 707, which uses this information to populate the member preferences determined by the member preference module 709 and/or the shipping options determined by the shipping alternative module 711. For example, using the example described above, the machine learning module 719 can communicate to the member preference module 709 to indicate that the user prefers shipments that arrive on a particular day or time of the week (e.g., beginning of the week). Alternatively or additionally, the machine learning module 719 (and/or the member preference module 709) can communicate to the shipping alternatives module 711 so that the shipping alternatives module 711 can determine which shipping options to cause presentation of to the user based on the information learned or predicted by the machine learning module 719. For example, using the example above, particular embodiments can offer a relatively higher incentive or price reduction for weekend delivery (e.g., to synchronize delivery with other shipments) if the shipping alternatives module 711 knows, via the machine learning module 719, that the user almost always has early weekday deliveries, knowing that it may take a lot of incentivizing to change the user's mind. This can be contrasted, for example, with a relatively lower incentives or price reduction for weekend delivery of another user if the shipping alternative module 711 determining that the different user always ships on weekends anyway, knowing that it will not take a lot of incentivizing.

As illustrated in FIG. 7, some or all of these determinations made by the member preference module 709 and the shipping alternatives module 711 can be transmitted back over to the checkout module 703 and caused to be presented to a user device, such that the user device can select shipping options and/or other shipping information.

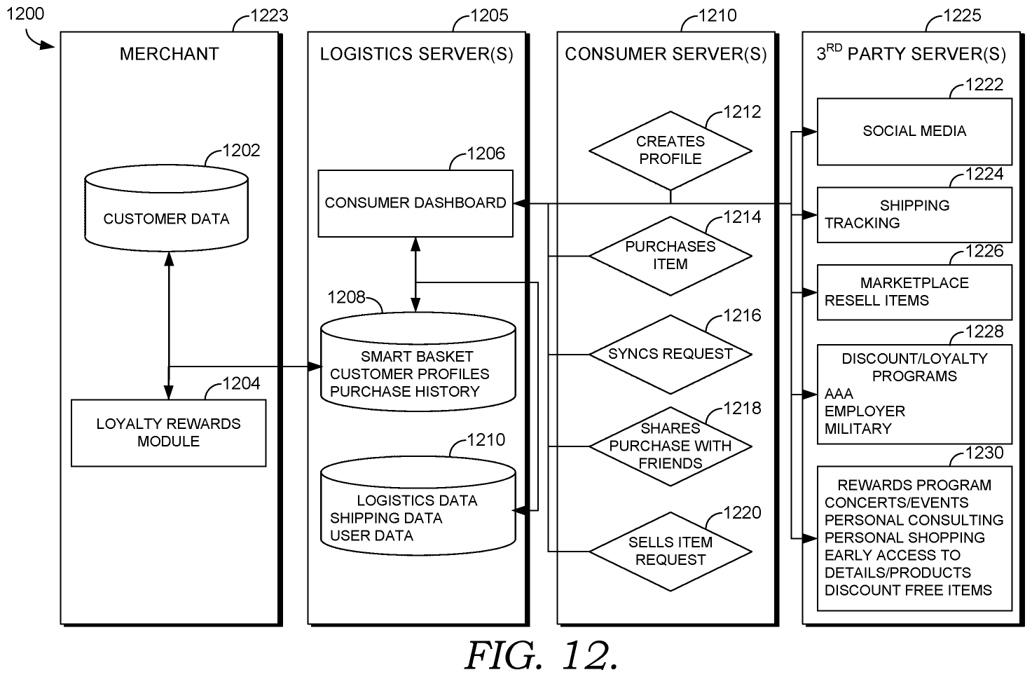

FIG. 12 is a block diagram of an example system 1200, in which aspects of the present disclosure are employed in, according to some embodiments. The system 1200 is generally responsible for integrating several functional components to generate a consumer dashboard, which gives consumers the ability to find the right product, get it on their own terms, share their experience with friends, and resell it when no longer needed. In some embodiments, the merchant server(s) 1223 represents the merchant server(s) 123 and vice versa. Likewise, in some embodiments, the logistics server(s) 1205 represent the logistics server(s) 105 and vice versa. Likewise, in some embodiments, the consumer device(s) 1212 represents the computing entity 110 and vice versa. Likewise, in some embodiments, the third party server(s) 1225 represent the third party server(s) 125 and vice versa.

As illustrated in FIG. 12, the consumer dashboard 1206 is generated by the logistics server(s) 1205 and caused to be displayed to the consumer device(s) 1210. The consumer dashboard 1206 includes recommended products/brands, social content, purchase history, logistics information, returns/warranty information, rewards, and functionality that re-sells used items, all of which is generated or provided by the third part server(s) 1225 and the merchant server(s) 1223.

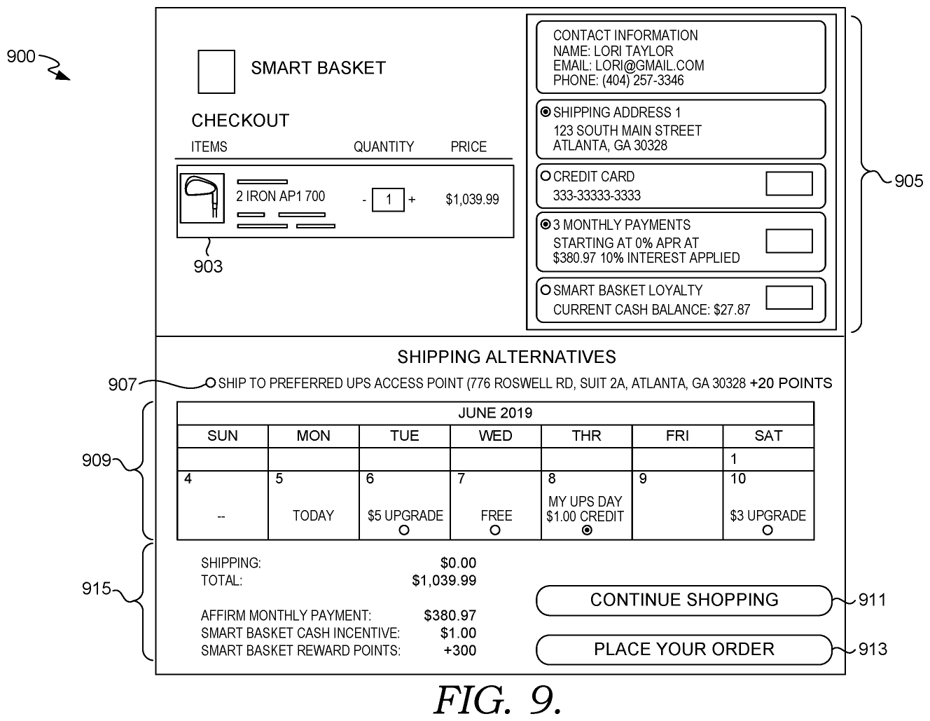

The customer data store 1202 is generally responsible for storing any suitable customer data, such as name, address, conversion information regarding specific products (e.g., clicks, purchases, queries, views), demographics information, billing, etc. This information is copied to the smart basket store 1208. The smart basket store 1208 includes additional user profile information, such as any logistics-based information (e.g., historical shipments made, billing information, additional conversion information, any learning of specific users (e.g., by the machine learning module 719 of FIG. 9). In some embodiments, information between the customer data store 1202 and the smart basket store 1208 can be exchanged.

The loyalty rewards module 1204 is generally responsible for generating certain incentives for specific customers. The loyalty rewards module 1204 may transmit specific identifiers indicating customers and current and/or historical incentives given to those customers to a module that stores the information to the smart basket store 1208 and/or to the customer data store 1202. Any information contained in the smart basket store 1208 (including incentives offered to users) is provided to the consumer dashboard 1206.

The logistic data store 1210 store logistics data, such as shipping and tracking data of a plurality of pending and/or historical shipments and user data. For example, the data can include package dimensions for pending shipments, billing information, and/or any data that can be included in applications, such as UPS MYCHOICE. This data is also fed to the dashboard 1206.

On the one or more consumer device(s) 1210 the user creates a user profile on an app, plug-in, extension, and/or web page. In some embodiments, in response to receiving user profile information, embodiments store it to the smart basket store 1208 or the customer data store 1202. Alternatively, in some embodiments, a user profile is automatically generated based on information contained in the customer data store 1202 and/or the smart basket store 1208. For instance, embodiments can automatically extract an IP address, device ID, and/or other ID of the consumer device(s) 12010, and match it to another ID contained in one of these data stores to obtain more information about the user.

In some embodiments, the consumer device(s) 1210 issues an item purchase request 1214. In some embodiments, the marketplace entity 1226 causes display or otherwise provides a list of products for the user to browse. Responsive to the user wanting to purchase an item, the purchase item request is sent to the market place entity 1226.

In some embodiments, the consumer device(s) 1210 alternatively or additionally issues a syncs packages request 1216. In some embodiments, the shipping entity 1224 (e.g., UPS) provides incentives or rewards to the consumer device(s) 1210 as described herein to consolidate or synchronize deliveries. Accordingly, in response to receiving the sync package request 1216 to synchronize deliveries, the shipping entity can cause synchronization of the deliveries.

In some embodiments, the consumer device(s) 1210 shares purchase with friends as indicated by 1218. For instance in response to issuing the purchase item request 1214 to purchase an item, the user can share the purchase with friends via the social media entity (e.g., FACEBOOK, SNAPCHAT, PINTEREST, YOUTUBE, TUMBIR, etc.). For example, an app on the consumer device(s) 1210 can communicate, over a network and via an API, with a social media server, which causes the purchase to be displayed to a social media post or mailbox.

In some embodiments, the consumer device(s) 1210 generates a sells item request 1220 to the marketplace entity (e.g., a reselling marketplace) to issue a request to sell an item. Responsively, the marketplace entity 1226 may provide an API that allows selling functionality to be integrated into the application on the consumer device(s) 1212.

In various embodiments, the one or more third party servers 1225 provide various information to the consumer dashboard 1206 and/or an application that includes the consumer dashboard 1206. For example, a social media entity 1222 can provide, to the dashboard 1206, each recent purchase a friend of the user of the consumer device(s) 1212 has recently made. In another example, the shipping entity 1224 can provide tracking functionality to the dashboard 1206 so that the user can track his or her packages. In another example, the discount/loyalty programs entity 1228 can provide different discounts or loyalty programs (e.g., AAA, Employer programs, Military, etc.) that will provide incentives or price reductions for items purchases in response to enrolling for or being a member of such loyalty programs. In another example, the rewards program entity 1230 can provide rewards programs so that wen users engage in specific events, the user will be granted reward points or incentives. For example, the events may be attending a concert, personal consulting (e.g., fashion, interior design), personal shopping (JETBLACK), early access to deals/products, and/or discounts/free items. In another example, the marketplace entity 1226 can provide functionality that allows the user to resell used items, provide product catalogs to browse for products, and the like. The discount/loyalty programs 1228 (e.g., AAA, employer, military) and/or the rewards program (e.g., concerts/events, personal consulting (e.g., fashion, interior design), personal shopping (e.g., Jetblack), early access to deals/products, discounts, free items) can provide functionality that allows the user to use or earn discounts, rewards, or loyalty points in response to (or contingent upon) purchasing one or more items.

### IV. Exemplary System Operation

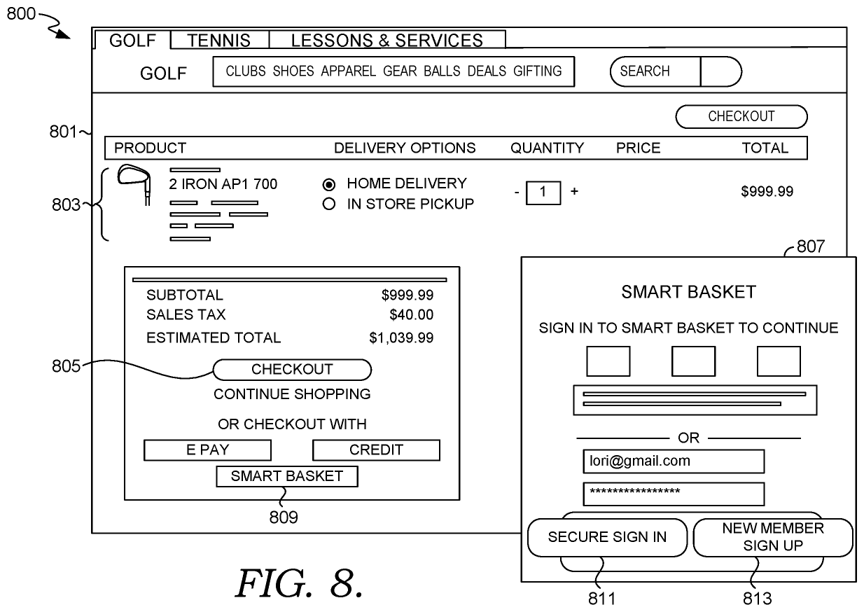

FIG. 8 is an example screenshot 800 illustrating merchant checkout functionality that is integrated with logistics functionality, according to some embodiments. In some embodiments, one or more merchant servers, such as the merchant server(s) 123 host the page 801 (e.g., a web page). The page 801 includes the checkout button 805 and the Smart Basket Pay button 809. In various embodiments, in response to receiving a user selection of the Smart Basket Pay button 809, embodiments cause the object 807 to be displayed, which provides fields that receive user information to log into a logistics account hosted on one or more logistics servers (e.g., the logistics server(s) 105 of FIG. 1).

The screenshot 800 illustrates that a user has selected the Titleist irons golf clubs to her shopping car and proceeds to checkout utilizing the integrated smart basket pay button 809. In response to receiving a user selection of the button 809, particular embodiments (e.g., the one or more merchant servers 123) cause the object 807 (e.g., a pop-up box) to be displayed. This object 807 prompts the user to sign into Smart Basket using her secure member account and password. As illustrated in the object 807, particular embodiments can receive a user selection of the button 811 if the user is already a member of the logistics account (i.e., has already input information for registration) or can receive a user selection of the button 813 if the user is not already a member of the logistics account (i.e., has not already input information for registration). Some embodiments can alternatively receive a selection of the checkout button 805 indicative of merchant checkout functionality that is not integrated with logistics checkout functionality. In this way, users can checkout using the sole checkout features of merchants, as opposed to integrated checkout functionality of logistics entities or any third party entities (e.g., PAYPAL).

In some embodiments, the page 800 represents a page of the application 701. Likewise, in some embodiments, the smart basket button 809 and the object 807 represents functionality provided by the checkout module 703 within the application 701. In some embodiments, the smart basket button 809 and the object 807 represents the merchant checkout module 412 of FIG. 4. In some embodiments, the smart basket button 809 and the object 807 represents functionality provided by the logistics checkout and offer module 513 of FIG. 5. In some embodiments the smart basket button 809 and the object 807 represents functionality provided by the direct logistics checkout module 616. Likewise, in some embodiments, the checkout button 809 and associated functionality represents functionality provided by the merchant checkout module 622.

FIG. 9 is an example screenshot 900 of logistics-based checkout functionality, according to some embodiments. In some embodiments, the screenshot 900 is caused to be displayed to a user device in response to receiving the information from the fields of the object 807 of FIG. 8. For example, in response to receiving a selection of the buttons 811 or 813, one or more merchant servers connect, over a computer network and via an API (e.g., the logistics API 705 of FIG. 7) with one or more logistics servers (e.g., that includes the logistic checkout module 707). Accordingly, even though the checkout functionality of the page 801 can be hosted on a merchant server(s) or other entity, logistics servers can provide integrated functionality that includes seamless and same look and feel and allows logistics entities to receive specific benefits from a transaction. In some embodiments, the information of the screenshot 900 is provided by the logistics checkout module 707 of FIG. 7. Specifically, for example, the member preference module 709 can cause presentation of all of the information within the UI element 905 (i.e., contact information, shipping address, credit card number, rewards points, and the like). The shipping alternative module 711 may cause presentation of the UI elements 907, 909, 915, 911, and 913.

The screenshot 900 specifically illustrates that the user logs into smart basket checkout functionality of the logistics entity and sees the following user preferences as indicated in the UI element 905—contact information, shipping address, credit card/ACH bank payment, smart basket loyalty rewards, free 2-day shipping and return, and package delivery preferences of the user (e.g., as learned by the machine learning module 719). The shipping alternatives (alternative to the “shipping address 1” illustrated in the UI element 905) are provided, allowing the user the choice of delivery speed, location, and potential rewards/savings tradeoffs.

Specifically, embodiments cause presentation of the field 907 allowing the user to ship to an access point to give the user 20 rewards points. Some embodiments learn (e.g., via the machine learning module 719) that this access point is popular or always selected by the user or other users near the user as an alternative destination shipping points. Various embodiments cause presentation of the UI element 909, corresponding to the different costs of shipping the item (golf clubs) corresponding to the indicia 903 depending on the date selected for shipping. As described herein, this different incentives and shipping dates can be selected based on learning by the machine learning module 719. Embodiments cause presentation of the UI element 915, which indicates the total shipping cost, as well as incentives (e.g., cash or rewards points) provided to the user based on the user selection made to the UI element 909. The user can either continue shopping or place an order. In response to receiving a user selection of the button 911, some embodiments (e.g., a logistics server) connect, over a network and via an API, back to the merchant server or other entity that hosts the page 801 to provide a browsing page such that the user can continue browsing products. Alternatively, in response to receiving a user selection of the button 913, embodiments can connect back to the merchant server or other entity to issue a confirmation or notification of the item(s) purchased and any other data, such as the information selected in the screenshot 900.

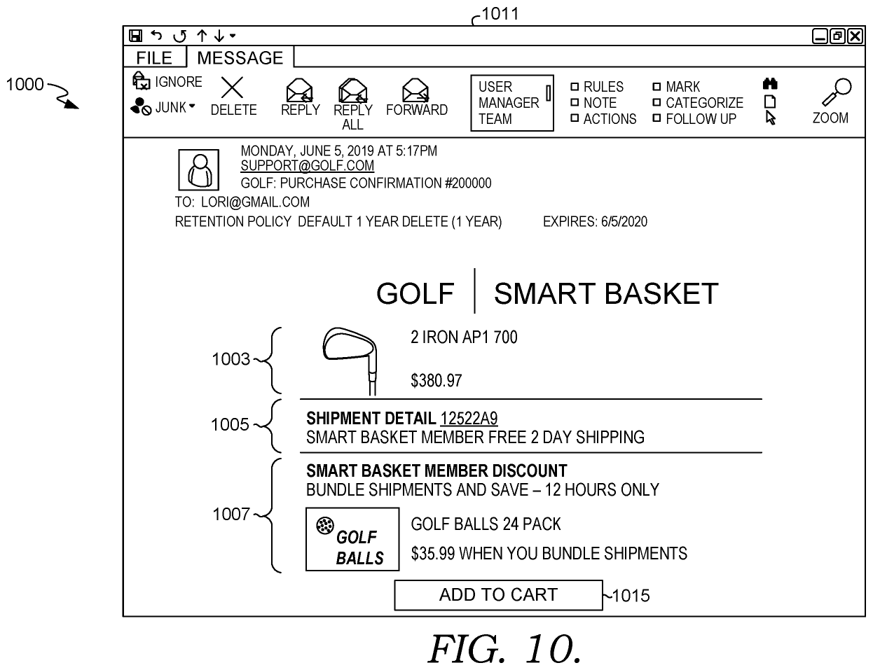

FIG. 10 is a diagram of an example screenshot 1000 of a notification, according to some embodiments. In some embodiments, the screenshot 1000 is caused to be provided to a user device in response to receiving a selection of the “place your order” button 913 of FIG. 9. In some embodiments, this notification represents the notification generated by the notification module 713 of FIG. 7. As illustrated in FIG. 10, the notification can be send via email as illustrated on the inbox page 1011 or via an app, as illustrated within the user device 1013. Alternatively or additionally, the notification can be transmitted through other channels, such as Short Message Service (SMS) text, via a social media service notification, etc. As illustrated in FIG. 10, the notification includes the elements 1003, 1005, and 1007. 1003 indicates the item (golf clubs) that the user purchased. 1005 indicates a link that when selected indicates logistics or shipping details, such as a tracking number identifier to track the parcel of the item, rewards points, service level data, or any other suitable information. Element 1007 indicates a complementary or other item (i.e., golf balls) related to the purchase of the item (i.e., golf clubs) indicated in the element 1003 that the user can be via incentives if the user bundles or consolidates a shipping of the golf balls with the golf clubs. If the user desired to this, embodiments can receive a selection of the button 1015 to further process the order of the golf balls.

In some embodiments, the complimentary or related product that is offered for sale is any suitable product that a machine learning module (e.g., the machine learning module 719) learns about. In some embodiments, this additional bundling product offered for sale need not be “related” or “complimentary” to the other product but can be any suitable product offering that the machine learning module 719 learns about. For example, the machine learning module 719 that this particular user has made various conversion selections (e.g., purchases, clicks, views, etc.) of boxing attire (e.g., or boxing attire that has become popular based on various user selections independent of this specific user). Accordingly, for example, instead of the golf balls advertisement being shown via the element 1007, a boxing attire (e.g., boxing gloves) advertisement can be offered for sale.

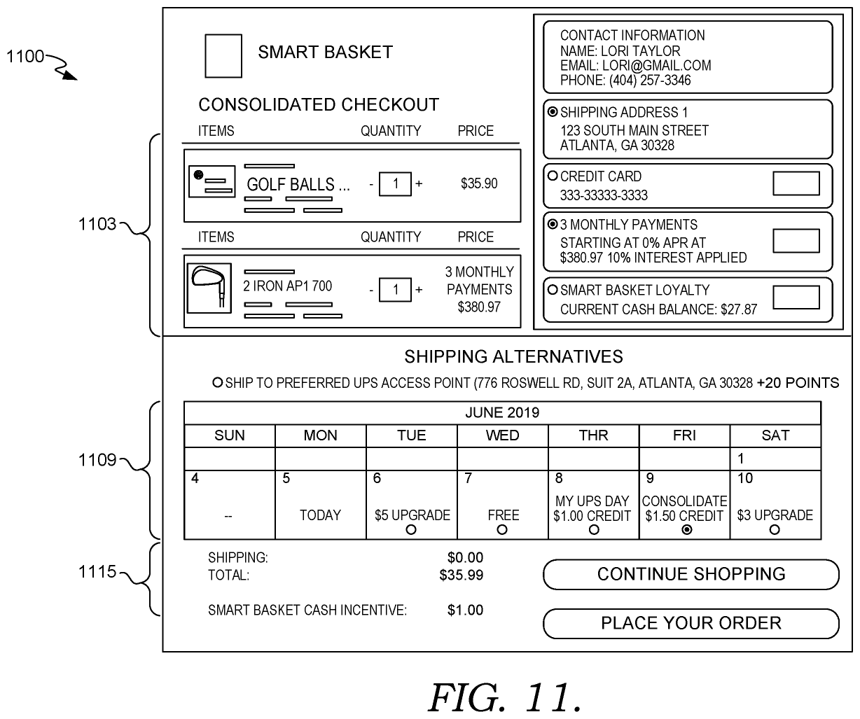

FIG. 11 is a diagram of an example screenshot 1100 of revised logistics checkout functionality, according to some embodiments. In some embodiments, the screenshot 1100 is hosted by one or more logistics servers (e.g., the logistics server(s) 105). In some embodiments, the screenshot 1100 represents an updated page relative to the screenshot 900 based on a user making a selection of a related, complimentary, or other product associated with an original purchase. Accordingly, for example, in response to receiving a user selection of the “add to order” button 1015, particular embodiments cause presentation of the screenshot 1100 to update the user's purchase order. In this way, in response to receiving a selection of an additional product in the notification, embodiments connect to the original merchant server (and/or logistics server) (e.g., iGOlf's website) where the user opts to use the smart basket pay button again (e.g., the button 809).

As illustrated in the snapshot 1100, the user is prompted to consolidate her two shipments—indicated in the UI elements 1103 (i.e., the golf clubs and golf balls)—to later that week (i.e., Friday) for a smart basket digital wallet cash back incentive of $1.50, which has been selected as illustrated in the UI element 1109. The UI element 1115 illustrates the total cost of shipping the complimentary golf balls based on reducing the total amount using cash incentives. In this way, the user can consolidate her shipment of both the golf balls and the golf clubs to Friday, as opposed to keeping an original shipping date of the golf clubs, which is illustrated as being on Thursday (one day earlier) according to the UI element 909 of FIG. 9. As described herein, this consolidation to a different date or any other adjustment of shipping options (or the providing of shipping options in general) can be based on data learned by the machine learning module 719 of FIG. 7. For example, a machine learning module can learn that this user has accepted shipments on Fridays in the past and that there will likely be many more shipments near the same area that the golf clubs will be delivered to on Friday. Accordingly, in order to save on fuel consumption and because the user has historically accepted shipments in the past on Friday, embodiments can offer the extra incentive of consolidation and the $1.50 credit for Friday.

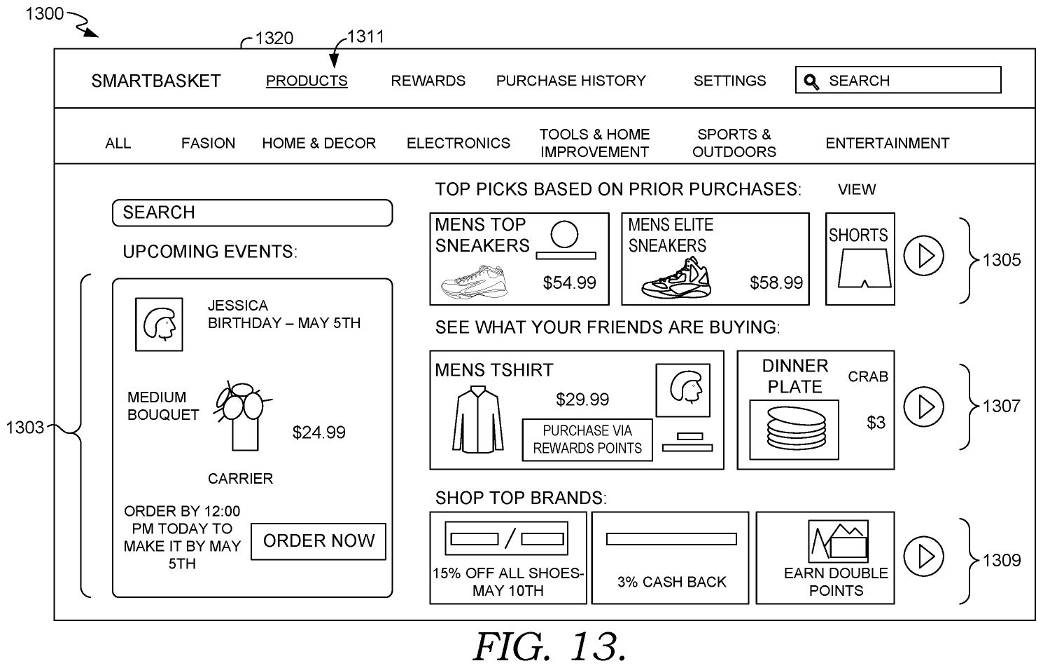

FIG. 13 is an example screenshot 1300 of a user interface dashboard illustrating functionality integrated with one or more third party servers, according to some embodiments. For instance, the screenshot 1300 can represent a logistics entity (e.g., the logistics server(s) 105) with information derived from multiple remote sources (via API functionality), such as social media, merchant servers, and the like. In this way, there is a reduction in queries, selections, or other user input to derive the same information separately from different sources. In some embodiments, the page 1320 (e.g., a web page) represents the consumer dashboard 1206 of FIG. 12. Some embodiments cause display of the page 1320 in response to receiving a selection of the “Products” identifier 1311.

UI element 1303 illustrates upcoming events and purchasing functionality associated with the upcoming events. Specifically, element 1303 indicates a particular birthday, and a set of flowers the user can purchase for the person whose birthday it is. In some embodiments, the birthday information is derived from one or more social media servers (e.g., the social media entity 1222 of FIG. 12). In some embodiments, the flower information is derived from one or more merchant servers (e.g., the marketplace entity 1226). In this way, the web page 1320 can have integrated API information from various remote resources. In some embodiments, the types of products recommended for birthdays or upcoming events associated with friends are determined by a machine learning model (e.g., the machine learning module 719 of FIG. 7). For example, a machine learning model can determine that the friend “Jessica” as indicated in the UI element 1303 likes flowers based on natural language processing (NLP) of historical posts in a social media account.

The UI element 1305 indicates top picks of potential products to purchase based on prior purchases (e.g., of the user herself and/or other users). In some embodiments, the information derived from the UI element 1305 is derived from one or more merchant servers (e.g., the marketplace entity 1226 of FIG. 12). In some embodiments, the generation of products within the UI element 1305 is based on using a machine learning model (e.g., the machine learning module 719).

The UI element 1307 illustrates items that the user's friends are buying. In some embodiments, this information is derived from one or more social media servers (e.g., the social media entity 1222 of FIG. 12). The UI element 1309 indicates the top brands to shop for, which may be provided by statistics generated by a merchant entity (e.g., the marketplace entity 1226).

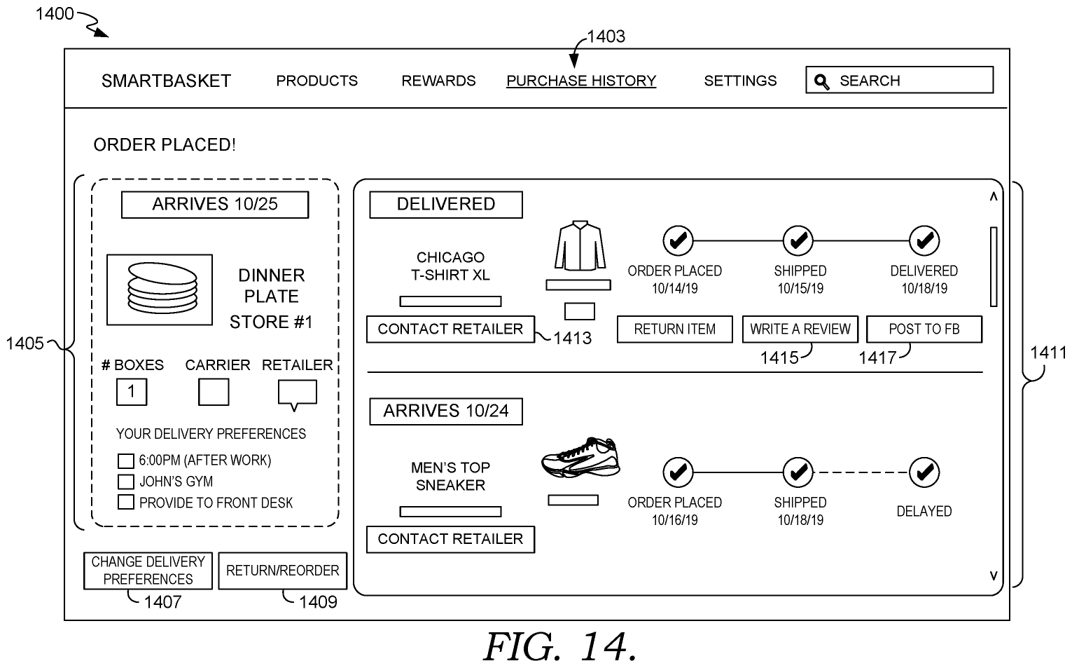

FIG. 14 is an example screenshot 1400 of a user interface illustrating purchase history of a user and associated shipping functionality, according to some embodiments. In some embodiments, the screenshot 1400 is caused to be displayed in response to receiving a user selection of the “purchase history” identifier 1403 within the page 1320 of FIG. 13.

The UI element 1405 indicates the item(s) purchased and its estimated shipping date. In some embodiments, the users “delivery preferences” are learned by one or more machine learning models (e.g., the machine learning module 719). Various embodiments receive input from the user to “contact retailer” and responsively communicate with one or more merchant servers the input. In various embodiments, the input may be indicative of the defective state of the item(s) purchased or whether the item purchased was the correct item. Some embodiments receive a request to change delivery preferences in response to receiving a selection of the change delivery preferences button 1407. In this way the user can tailor delivery preferences at any time. Some embodiments initiate (e.g., via communicatively coupling to a merchant server 123) a request to return or re-order a purchased product in response to receiving a user selection of the button 1409. Accordingly, for example, a logistics server(s) 105 can communicate with a merchant server(s) 123 so that the user is brought to a merchant server web page where the user can input information indicative of a return item request.

The UI element 1411 indicates where in the shipping process a purchased item is. Some embodiments communicate with one or more merchant servers in response to receiving a user selection of the button 1413 so that the user can input one or more messages (e.g., chat messages) or otherwise contact the merchant. Some embodiments provide a field or other object to the user in response to receiving a selection of the button 1415. In this way a user can write a review of the product delivered and in response to receiving the data in the field or other object, embodiments can store the review so that other users can view the review. Some embodiments communicate with a social media server in response to receiving a user selection of the button 1417, which is indicative of a request to post the purchase of the item to one or more friends of the user's social media account. Accordingly, for example, a logistics server(s) 105 can establish a session with a social media server, and forward to the social media server, via an API, a request to post the purchase of the item to all the user's friends.

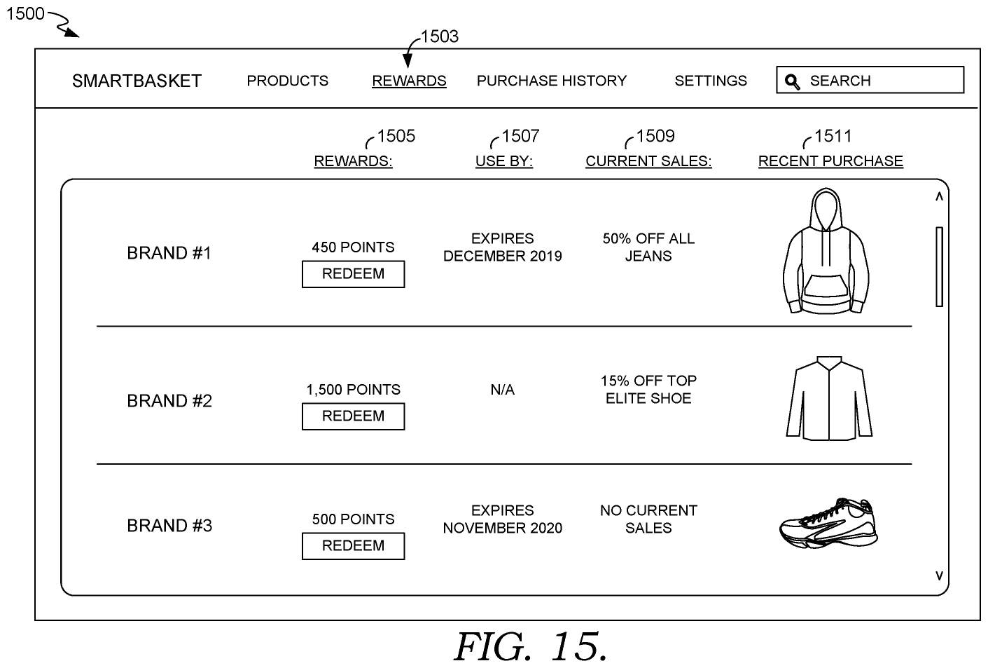

FIG. 15 is an example screenshot 1503 of a user interface illustrating various incentives offered for recently purchased products, according to some embodiments. In some embodiments, the screenshot 1500 is generated and caused to be displayed in response to receiving a user selection of the “rewards” identifier 1503 within the page 1320 of FIG. 13.

Column 1511 indicates the recent purchases that a user has made. In some embodiments, the rewards points indicated in the screenshot 1500 is derived from one or more merchant server(s) (e.g., the marketplace entity 1226). Column 1505 indicates the rewards points associated with the recent purchases and/or a particular brand. For instance, the column 1505 may indicate how many rewards points the user has accumulated to date for a particular brand/product. Rewards points may be indicative of a point system where prices of products can be reduced by a certain percentage or value in response to the points reaching some threshold number. Column 1507 indicates when the date that the rewards points expire. Column 1509 indicates current sales for the particular brand/merchant store or products associated (e.g., related) to the recent purchases indicated in the column 1511.

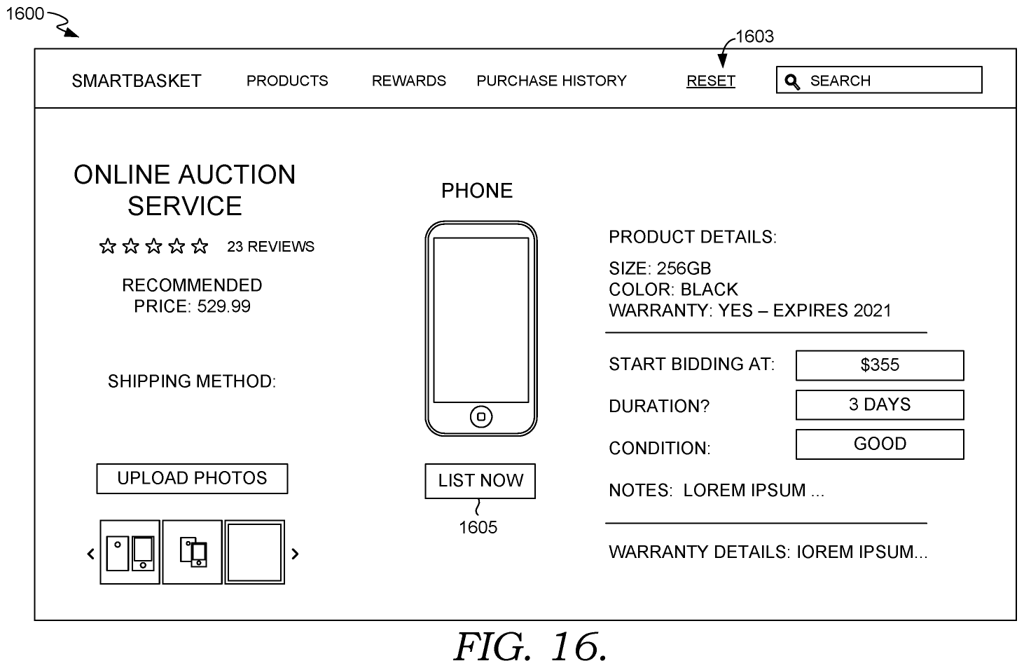

FIG. 16 is an example screenshot 1600 of a user interface indicating an item that the user is reselling, according to some embodiments. In some embodiments, the screenshot 1600 is generated and caused to be displayed in response to receiving a selection of the “resell” button 1603 within the page 1320 of FIG. 13. In some embodiments, the bidding and other reselling functionality occurs via API functionality to integrate with marketplace or other reselling entities (e.g., the marketplace 1226 entity). In this way, users can list items for sell, set bidding caps, indicate duration of the bid, condition of the item, upload any pictures, and/or provide the shipping entities. Some embodiments initiate the bidding process in response to receiving a user selection of the “list now” button 1605. For example, in response to receiving a user selection of the “list now” button 1605, embodiments communicate, over a network, with a reselling server and initiate a bidding via an API so that the reselling server can track or otherwise manage the bidding.

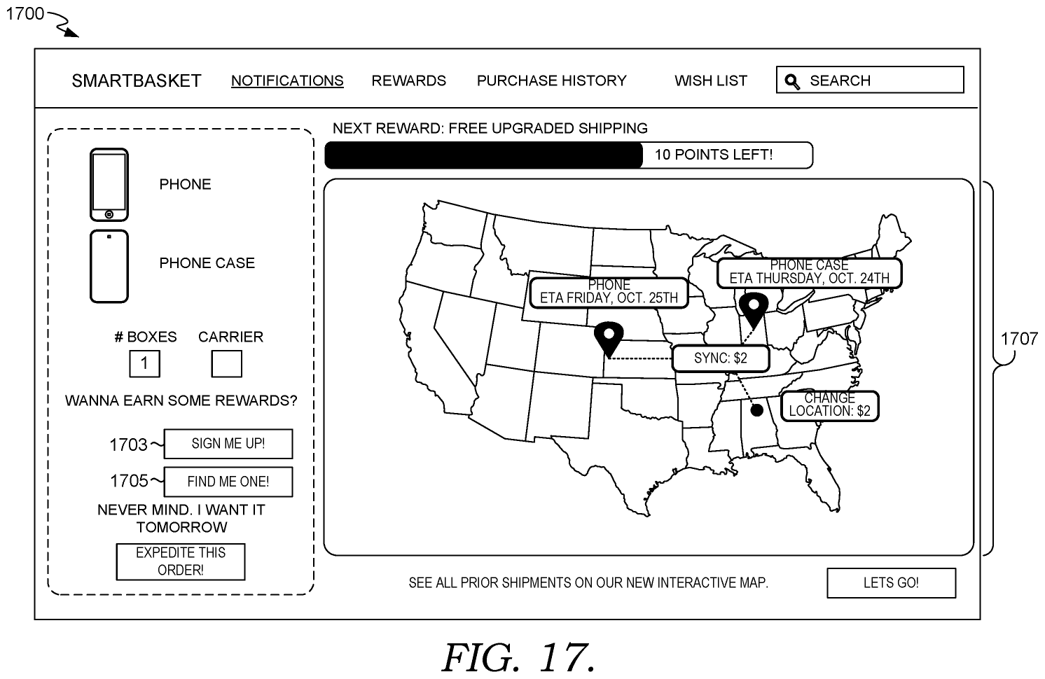

FIG. 17 is an example screenshot 1700 indicates incentives that are offered based on the user complying with shipment options, according to some embodiments. The screenshot 1700 indicates that the user has purchased both a phone and a case for the phone. The electronic map 1707 indicates that the phone has an original shipping date of arrival on October 25, whereas the case has an original shipping data of arrival on October 24^{th}. The screenshot 1700 further indicates that the user can get both items on October 25 (consolidate or synchronize delivery) to get 10 rewards points. In some embodiments, the determination to make this shipping offer is determined by the shipping alternatives module 711 via machine learning module 719 of FIG. 7, as described herein. The screenshot 1700 further indicates that the user can change the destination location to an access point to earn an additional 10 points or two dollars off. In some embodiments, the determination to change shipping locations is determined by the shipping alternatives module 1709 via the machine learning module 719 of FIG. 7, as described herein. In response to receiving a user selection of the button 1703, particular embodiments change a record in memory (e.g., a database record) to change the delivery of shipments to the same day. Likewise, in response to receiving a user selection of the button 1703, particular embodiments generate and cause display of a list of access points closest to the original shipping address. And in response to receiving a user selection of one of the access points, particular embodiments change, in memory, a record indicating that the shipments will now go to the selected access point. It is understood that any shipment option can be modified alternative or in addition to shipping date and shipping location. For example, service level can be upgraded. For instance, embodiments can upgrade or downgrade speeds (e.g., Ground to NDS, Ground to SP, etc.). In this way, after shipment or a request to purchase a first item, certain embodiments offer consumers incentives, while improving cost and learning consumer preferences to validate a model. For instance, any selections made to the screenshot 1700 can be saved to the user profile data store 715 so that the machine learning module 719 can learn consumer preferences. For example, embodiments can learn that most users in an area where an item was to be originally shipped to an access points. Accordingly, embodiments can indicate that this access point is an option for shipping within the screenshot 1700 to earn the 10 points.

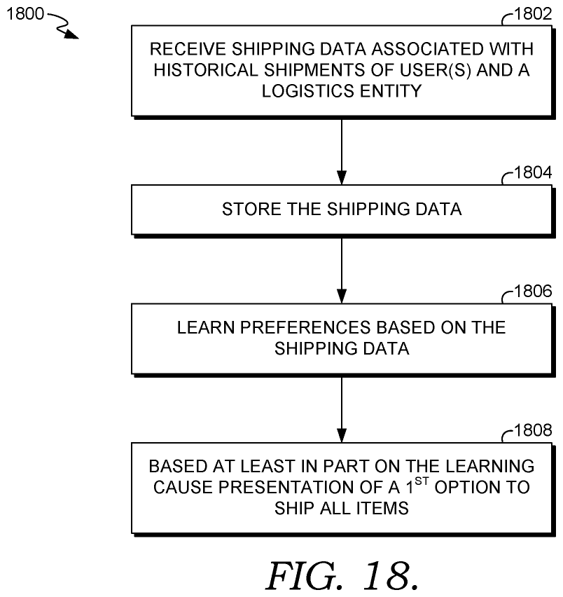

FIG. 18 is a flow diagram of an example process 1800 for learning preferences based on shipping data, according to some embodiments. The process 1800 (and/or any of the functionality described herein, such as process 1900 or 2000) may be performed by processing logic that comprises hardware (e.g., circuitry, dedicated logic, programmable logic, microcode, etc.), software (e.g., instructions run on a processor to perform hardware simulation), firmware, or a combination thereof. Although particular blocks described in this disclosure are referenced in a particular order at a particular quantity, it is understood that any block may occur substantially parallel with or before or after any other block. Further, more (or fewer) blocks may exist than illustrated. Any added blocks may include blocks that embody any functionality described herein (e.g., any functionality described with respect to FIGS. 1 through 17). The computer-implemented method, the system (that includes at least one computing device having at least one processor and at least one computer readable storage medium), and/or the computer program product/computer storage media as described herein may perform or be caused to perform the process 1800, and/or any other functionality described herein. In some embodiments, the logistics server(s) 105 performs the process 1800. Alternatively, some or all of the components of FIG. 1 performs the process 1800.

Per block 1802, shipping data associated with historical shipments of one or more users and a logistics entity (e.g., the logistics server(s) 105 of FIG. 5) are received. Per block 1804, this shipping data is stored (e.g., in a database). In some embodiments, this stored information corresponds to data/data stores as described herein with respect to the user profile data store 715, the smart basket profile 408, the smart basket profile 503, the smart basket consumer profile 606, and/or the smart basket 1208. In some embodiments, this shipping data represents or includes shipment selections made by one or more users for a plurality of shipments. These user selections can be made via an application (e.g., a web application or app) or at a logistics store inputted by clerk personnel or users. For example, the user selections can include the service level used when shipping an item, the address selection of users to deliver an item, a selection of whether to synchronize shipments, a selection of the date that delivery will be made, a selection of acceptable consignees for a shipment, a selection of special instructions to ship an item, a selection of shipping parcel sizes used to ship an item (e.g., as indicated in a MYCHOICE UPS application), and/or any other selection.

In some embodiments, blocks 1802 and 1804 need not store “shipping data” (or only store shipping data). Rather, particular embodiments additionally or alternatively receive any profile data indicative of one or more attributes associated with the one or more users and store the profile data. For example, the one or more attributes may include the address of a user, demographic information about the user (e.g., age, residence, etc.), likes or interests of a user (e.g., shopping interests as determined by the machine learning module 719 and/or a third party social media server), shipping data, conversion actions (e.g., buys, sells, views, purchases) and/or any other suitable data concerning a user.

Per block 1806, some embodiments learn preferences based on the shipping data. In some embodiments, this includes functionality as described with respect to the machine learning module 719. Alternatively or additionally, particular embodiments learn, via a machine learning module, preferences based on the user input or selections. In an illustrative example of block 1806, embodiments can learn that although a user's profile data indicates his or her preferred shipping address, the last 3 shipments have been made to a first access point and so the next shipment is likely to be made at the first access point. Accordingly, embodiments can classify or predict that the user will likely want a shipment to be made at the first access point instead of the address.

In some embodiments, the learning includes one or more of: learning a day of week that one or more users have historically shipped on (e.g., packages have arrived at location Z 80% of the time), a shipping destination location that the one or more users have historically shipped an item to (e.g., delivery address Y has been used to ship over 90% of packages for user A), a service level that the one or more users have historically used, and package dimensions (e.g., weight, length, width, height, and/or volume) of packages that the user has historically shipped (e.g., user has predominantly shipped packages over 10 pounds each shipment). This learning can be use to make predictions or classification, such as what day of week the user is likely to ship on, a shipping destination location for a shipment, a service level that the user is likely to use, and probably package dimension. In some embodiments, the learning includes learning the delivery density of parcels. “Delivery density” as described herein refers to the amount of parcels that are to be delivered within a specific time window (e.g., a particular day) to a particular destination point (e.g., address or geocode) or area (e.g., geofence, neighborhood, apartment complex, zip code) associated with the particular destination point. In this way, suggested shipping options for a shipment for a first destination at first time, and the like can be based at least in part on the delivery density associate with the first time and first destination can be based on other shipments that are delivered within a threshold of the first time and/or other destinations within a distance of the first destination.

Some embodiments offer the learnings achieved per block 1806 directly to consumers to validate the model and/or use these learnings to enable an in-cart solution for merchants via n API or other integrated functionality. For example, some embodiments may generate a notification that states something like, “we see that you have shipped at address X the last three times, do you want to keep shipping here?” In this way, the user can validate the learning through post hoc learning. In some embodiments, logistics entities can offer solutions or shipping options after the shipment has been created (or items being requested to be delivered) through email notifications, apps, consumer hubs, giving logistics entities full control over changes. Alternatively or additionally, at checkout, embodiments can integrate with merchant entities to connect logistics functionality to consumers at merchant checkout when using an easy pay button or the like (e.g., the button 809). In this way, logistics entities can offer unique pricing or shipping options based on the location, service level, shipping density, and/or the like with incentives. For example, the delivery location can be changed (e.g., to/from access point, work address, etc.), shared savings (e.g., waive free returns, pay with a debit card, etc.), service level (e.g., upgrade or downgrade speeds of shipment (e.g., Ground to NDA, Ground to SP, etc.), shipping density (e.g., to incent improved delivery density to home (e.g., SDS package match, day of week).

In some embodiments, the learning at block 1806 learns consumer preferences and improves those recommendations over time (e.g., via various epocs or rounds to improve confidence levels). In some embodiments, learning recommendations can be initially based on look-alike consumers (e.g., because there is not enough data for a given user) relative to a first user. For example, embodiments can determine that a particular neighborhood that the first user lives in is generally more likely to use access point X relative to other neighborhoods. Accordingly, embodiments can recommend a delivery option of access point X for presentation to the first user at block 1808. However, during a learning phase, the model can be refined by shifting from generic recommendations to personal recommendations. For example, over time the first user may have requested several shipments and embodiments learn that the first user uses access point X only sometimes but rather uses access point Y. Embodiments can determine that although access point X is closer to his or her home, access point Y is closer to the first user's work and accordingly recommend shipment to access point Y (instead of access point X) per block 1808 based on this specific user's input data. Accordingly, some embodiments thus offer personalized recommendations based on individual needs (or group of individuals) by date, time location, retailer (e.g., access point).

Per block 1808, particular embodiments cause presentation of a first option to ship an item based at least in part on the learning. In some embodiments, this presentation is at a web page or app page of a computing device of a user. In some embodiments, block 1808 additionally or alternatively includes a second option to earn one or more incentive for a particular user. Some examples of block 1808 are described with respect to the functionality described with respect to the shipping alternatives listed in FIG. 9 and/or FIG. 11 (e.g., specifically the UI element 1109).

In particular embodiments, logistics entities (e.g., the logistics server(s) 105) calculate a baseline cost estimate then offer consumers relevant actions that would adjust the cost position (e.g., as described with respect to the shipping alternative module 711). For instance, referring back to FIG. 17, the baseline cost may be calculated to ship the phone case on October 24 to a first home address. The “cost” may be in terms of miles driven, fuel consumed, man hours used, actual money or any other costs. Accordingly, the cost may be over a threshold. Therefore, prior to or as a part of block 1808, embodiments generate and cause display of a new shipment option (e.g., as indicated in the UI element 1109 of FIG. 11 or described with respect to the shipping alternatives module 711) to ship to an access point and an option to synchronize both shipments to October 25, as illustrated in FIG. 17.

Particular embodiments generate a shipping option to ship the first item and embodiments further cause presentation based at least in part on the learning, via the machine learning model, a second item to the computing device and cause presentation of an indication that the second item can be purchased contingent upon adhering to the shipping option in order to receive one or more incentives. In some embodiments, the shipping option that must be adhered to in order to receive the one or more incentives includes synchronizing delivery for the first item and the second item such that the first item and the second item are delivered to a same destination for a single delivery. For example, this is described with respect to FIG. 11 where the shipping option is to consolidate the shipping of the golf clubs (e.g., the first item) and golf balls (e.g., the second item) to Friday June 9^{th} in order to receive the credit.

In some embodiments the one or more incentives include at least one incentive of a group of incentives consisting of: a reduction in price to ship the first item (e.g., as illustrated by the “$1.00 credit in the element 1109) free return policy for the first item (e.g., as illustrated by the “FREE” June 7^{th} shipping date within the UI element 1109, and rewards points (e.g., as indicated by the “earn 10 points” incentives of FIG. 17).

Some embodiments additionally or alternatively increment one or more incentives based on the purchase of the first item and the second item. For example, referring back to FIG. 9 and FIG. 11, embodiments can offer more rewards points, as indicated in the element 907 and/or reduce the amount of shipping costs (e.g., indicated in the element 1109). Some embodiments generate a shipping option that must be chosen to receive one or more incentives, where the shipping option includes changing a destination that the first item is delivered to from a first destination to a second destination. This is described, for example, with respect to FIG. 17 where the first destination is changed to an access point to earn tem points. Some embodiments generate a shipping option that must be chosen to receive one or more incentives, where the shipping option includes changing a time period that the first item will be delivered to a destination from a first time period to a second time period. This is also described with respect to FIG. 17 where the shipping date is changed for the phone case from October 24^{th} the October 25^{th}.

In some embodiments, the causing presentation at block 1808 of a first option to ship a first item (or a second option to earn one or more incentives) for a particular user occurs via an API of a logistics entity that is embedded into a web application of an electronic marketplace (or merchant) checkout functionality, and wherein the first option or second option is provided in response to a selection of the first item via the checkout functionality. Examples of this are described with respect the screenshot 900 that is integrated into the checkout functionality associated with the screenshot 800 of FIG. 8. Other examples include the logistics checkout module 707 that is integrated into the checkout module 703 of the application 701 via the logistics API 705.

In some embodiments, the causing presentation occurs on the app page and not the web page such that the one or more portions of the app page correspond to an extension or plugin that is associated with data locally installed on the computing device. Examples of this are described with respect to the system 800 where consumers install an app, extension, or plugin that gives them control over the checkout process and access to logistics benefits, including shipping options using one or more incentives.

In some embodiments, the process 1800 includes user purchase request functionality prior to block 1808. Specifically, some embodiments receive an indication of a user request associated with a user purchasing a first item, the user request is issued at a web page or app page of a computing device. Examples of this are described with respect to the screenshot 800 where embodiments receive the user request to purchase the golf clubs indicated in the UI element 803. In this way, the causing of presentation at block 1808 may additionally occur in response to the receiving of the user request, as described, for example, with respect to FIG. 9, FIG. 10, and/or FIG. 11. In some embodiments, logistics server(s) 105 receive this “indication” (e.g., a notification or flag or Boolean value) of this user request even though, for example, a merchant server(s) 123 may be the direct recipient of the user request. In these embodiments, the logistics server(s) 105 still receive information indicating a user request has been issued for a specific user so that it can provide shipping option functionality, as described, for example, with respect to FIGS. 9, 10, and/or 11.

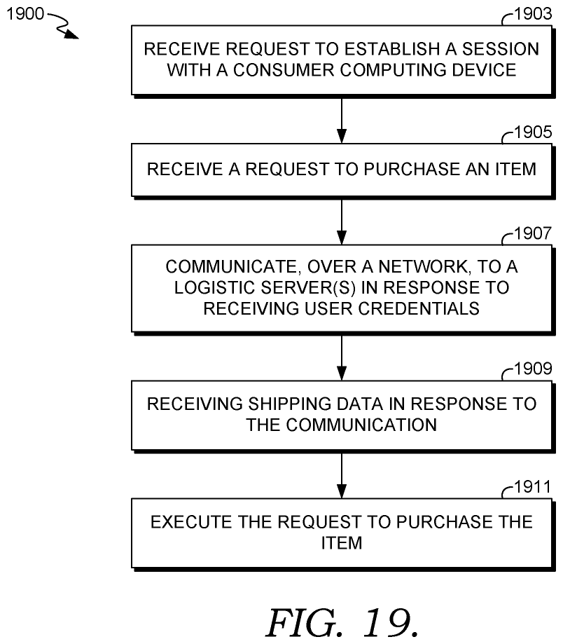

FIG. 19 is a flow diagram of an example process 1900 for executing a user request to purchase an item, according to some embodiments. In some embodiments, the one or more merchant servers 123 is the entity that performs the process 1900. In some embodiments, block 1903 occurs subsequent to the blocks 1802, 1804, and 1806. Likewise, in some embodiments the causing presentation of block 1808 of FIG. 18 occurs in response to the process 1900 of FIG. 19 such that block 1808 at least partially in response to receiving a user request to purchase an item.

Per block 1903, some embodiments receive a request to establish a session with a consumer computing device. For example, a merchant server 123 may perform a TCP/IP handshake with computing entity 110 to establish a connection over a network. This may occur in response to receiving a URL to direct a user to a merchant web page so that the user can browse items for sale. Per block 1905, subsequent to the session being established, particular embodiments receive a request to purchase an item. For example after a user is browsing a web application or otherwise engaging in the session, referring back to FIG. 8, a merchant server(s) 123 can receive a request from the user to purchase the golf clubs.

Per block 1907, embodiments communicate, over a network (e.g., a wireless transmission protocol network) to one or more logistics servers in response to receiving user credentials. For example, referring back to FIG. 8, in response to a merchant server 123 receiving credentials that the user inputs into the object 807, the merchant server can communicate to the logistics server(s) 105 (e.g., “sign in to smart basket to continue”) so that the consumer computer can display logistics entity views or pages, as illustrated by the screenshot 900 of FIG. 9. In some embodiments, the merchant server(s) or other entity alternatively or additionally transmits a request for particular information via an API for specific information. For example, particular embodiments can transmit a consumer device ID, IP address of the consumer device, data object (e.g., a cookie) that details consumer information, such as user name to an API, after which the logistics server matches the information with the request (e.g., a name) via a mapping or data structure (e.g., a lookup table) to lookup desired information. For example, the logistics server can use the transmitted consumer name as a key in a data structure to find the consumer's login information, shipping history, and/or any data used determine the screenshot 900 of FIG. 9.

Per block 1909, some embodiments receive shipping data at least partially in response to the communicating. For example, referring back to FIG. 9, in response to the communicating, the user can be brought to the screenshot 900 where the user inputs all the necessary preference information and shipping alternatives to choose a shipping selection. In response to receiving this information, the logistics entity can communicate, over the network any of the shipping selections made to the screenshot 900 to the merchant server so that the merchant server can receive shipping data per block 1909.

Per block 1911, particular embodiments execute the request to purchase the item. The execution of the request can include storing, in computer memory, a record of a purchase of one or more items. The execution of the request can include closing out or completing a transaction or purchase of an item. In an illustrative example, in response to receiving a user selection of the “place your order” button within the element 1115, the merchant server(s) 123 to store a record in memory indicating the purchase and cause presentation of a confirmation page so that the user can print out the order confirmation.

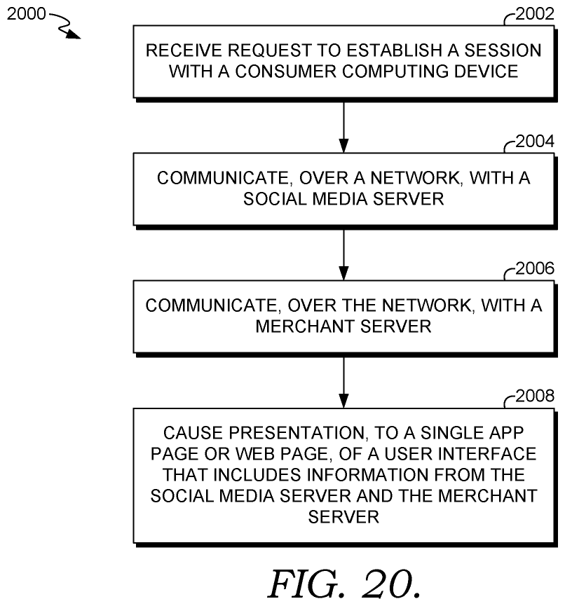

FIG. 20 is a flow diagram of an example process 2000 for generating a single app page or web page of a user interface that includes information from various remote resources, according to some embodiments. In some embodiments, the process 2000 is performed by the one or more logistics server(s) 105 and/or one or more of the components of the system 1200 of FIG. 12.

Per block 2002, a request to establish a session with a consumer computing device is received. For instance, one of the logistics servers 105 can receive a request to engage in a three-way handshake (i.e., SYN, SYN-ACK, ACK) with the computing entity 110. This TCP 3-way handshake is a process used in TCP/IP networks to make a connection between server and client where both client and server exchange synchronization and acknowledgement packets before a session starts. In an illustrative example, the logistics server(s) 105 can receive a handshake request from the computing entity 110.

Per block 2004, particular embodiments communicate, over a network (e.g., a TCP/IP network transfer protocol network) with a social media server. For example, in response to receiving the request per block 1202, particular embodiments automatically (without an explicit user request) establish a three-way handshake or other communication session with a social media server (e.g., the third party server(s) 125). In some embodiments, the logistics server(s) 105 or other entity additionally transmits a request for particular information via an API for specific information. For example, particular embodiments can pass a consumer device ID, IP address of the consumer device, data object (e.g., a cookie) that details consumer information, such as user name to an API, after which the social medial server matches the information with the request (e.g., a name) via a mapping or data structure (e.g., a lookup table) to lookup desired information. For example, the social media server can use the transmitted consumer name as a key in a data structure to find the consumer's social media account and the consumer's friends or social network.

Per block 2006, some embodiments additionally (or alternatively) communicate, over the network, with a merchant server (e.g., another third party server(s) 125). For example, in response to receiving the request per block 1202, particular embodiments automatically (without an explicit user request) establish a three-way handshake or other communication session with a merchant server. In some embodiments, the logistics server(s) or other entity additionally transmits a request for particular information via another API for specific information. For example, particular embodiments can transmit a consumer device ID, IP address of the consumer device, data object (e.g., a cookie) that details consumer information, such as user name to an API, after which the merchant server matches the information with the request (e.g., a name) via a mapping or data structure (e.g., a lookup table) to lookup desired information. For example, the merchant server can use the transmitted consumer name as a key in a data structure to find the consumer's conversion data (e.g., clicks, views) for specific products.

Per block 2008, particular embodiments cause presentation, to a single app page or web page of a user interface, of information from the social media server and the merchant server. For example, in response to blocks 1204 and 1206, particular embodiments (e.g., the logistics server(s)) automatically (without an explicit user request) cause display of a web page identical or similar to the web page 1320 of the screenshot 1300 of FIG. 13. In this way, various information from the social media server (e.g., Jessica's birthday, “see what friends are buying”) are formatted and displayed, as well as information from the merchant server (e.g., “top picks based on prior purchases” or “shop top brands.”) all in a single page, which improves existing technologies that require repetitive queries, user selections, inputs, as described herein. In some embodiments, block 2008 additionally or alternatively includes views or screenshots similar or identical to the screenshots 1400, 1500, and/or 1600 as described herein with respect to FIGS. 14, 15, and 16 respectively.

In some embodiments, this various information coming from different resources (e.g., social media servers and merchant servers) is re-formatted relative to its format that existed in its original form so that it can fit on the single app or web page. In some embodiments, this re-formatting, includes communicating, via an API, with each resource, and when the web browser renders the web page or web application to the user device using its Document Object Model (DOM) interpreter to display markup HTML for structuring a web page and Cascading Style Sheets (CSS) interpreter to style the web page, the CSS receives information from the API to condense the displayed information so that other pages or information can fit on the page.

### Definitions

“And/or” is the inclusive disjunction, also known as the logical disjunction and commonly known as the “inclusive or.” For example, the phrase “A, B, and/or C,” means that at least one of A or B or C is true; and “A, B, and/or C” is only false if each of A and B and C is false.

A “set of” items means there exists one or more items; there must exist at least one item, but there can also be two, three, or more items. A “subset of” items means there exists one or more items within a grouping of items that contain a common characteristic.

A “plurality of” items means there exists more than one item; there must exist at least two items, but there can also be three, four, or more items.

“Includes” and any variants (e.g., including, include, etc.) means, unless explicitly noted otherwise, “includes, but is not necessarily limited to.”

A “user” or a “subscriber” includes, but is not necessarily limited to: (i) a single individual human; (ii) an artificial intelligence entity with sufficient intelligence to act in the place of a single individual human or more than one human; (iii) a business entity for which actions are being taken by a single individual human or more than one human; and/or (iv) a combination of any one or more related “users” or “subscribers” acting as a single “user” or “subscriber.”

The terms “receive,” “provide,” “send,” “input,” “output,” and “report” should not be taken to indicate or imply, unless otherwise explicitly specified: (i) any particular degree of directness with respect to the relationship between an object and a subject; and/or (ii) a presence or absence of a set of intermediate components, intermediate actions, and/or things interposed between an object and a subject.

The terms first (e.g., first request), second (e.g., second request), etc. are not to be construed as denoting or implying order or time sequences unless expressly indicated otherwise. Rather, they are to be construed as distinguishing two or more elements. In some embodiments, the two or more elements, although distinguishable, have the same makeup. For example, a first memory and a second memory may indeed be two separate memories but they both may be RAM devices that have the same storage capacity (e.g., 4 GB).

The term “causing” or “cause” means that one or more systems (e.g., computing devices) and/or components (e.g., processors) may in in isolation or in combination with other systems and/or components bring about or help bring about a particular result or effect. For example, the logistics server(s) 105 may “cause” a message to be displayed to a computing entity 110 (e.g., via transmitting a message to the user device) and/or the same computing entity 110 may “cause” the same message to be displayed (e.g., via a processor that executes instructions and data in a display memory of the user device). Accordingly, one or both systems may in isolation or together “cause” the effect of displaying a message.

The term “real time” includes any time frame of sufficiently short duration as to provide reasonable response time for information processing as described. Additionally, the term “real time” includes what is commonly termed “near real time,” generally any time frame of sufficiently short duration as to provide reasonable response time for on-demand information processing as described (e.g., within a portion of a second or within a few seconds). These terms, while difficult to precisely define, are well understood by those skilled in the art.

The term “coupled” to refers to two or more components being attached, fixed, or otherwise connected. Any suitable component can be used to couple components together, such as one or more: screws, bolts, nuts, hook fasteners, nails, etc.

The term “session” described herein can be initiated when a user logs into a site, or is recognized by the site as returning user who is associated with activity on the site. For example, a site may recognize a returning user via cookies. A session can be considered terminated after a user logs off of a site or becomes inactive (or idle) on the site for a predetermined period of time. For example, after 30 minutes of idle time without user input (i.e., not receiving any queries or clicks), the system may automatically end a session.” In a multi-device world, the conventional definition of a session is becoming increasingly inapplicable. Viewed more broadly, a session in this disclosure includes the idea that the user is trying to achieve a particular task, with that task potentially spread over multiple devices and extended time period. The user could pick up a session on a different device, or after a lapse of time, and so forth. A user could have many parallel sessions going on simultaneously, for example. A session may include user phases, such as a discovery phase, an exploratory phase, a follow-up phase, and so forth. Sessions may be assessed or tied to a success metric, such as a “Bid-Buy-Offer-Watch-Ask seller question” (BBOWA) metric, for example.

The following embodiments represent exemplary aspects of concepts contemplated herein. Any one of the following embodiments may be combined in a multiple dependent manner to depend from one or more other clauses. Further, any combination of dependent embodiments (e.g., clauses that explicitly depend from a previous clause) may be combined while staying within the scope of aspects contemplated herein. The following clauses are exemplary in nature and are not limiting:

What is claimed is:

1. A computer-implemented method comprising:
receiving profile data indicative of one or more attributes associated with one or more users;
storing, in computer memory, the profile data;
learning, via a machine learning model, preferences based on the profile data;
receiving an indication of a user request associated with a user purchasing a first item, the user request being issued at a web page or app page of a computing device; and
in response to the receiving of the user request and based at least in part on the learning, causing presentation, at the web page or app page of the computer device, of one or more shipping options to ship the first item.

2. The method of claim 1, further comprising:
generating a shipping option to ship the first item; and
presenting, based at least in part on the learning, via the machine learning model, a second item to the computing device and presenting an indication that the second item can be purchased contingent upon adhering to the shipping option in order to receive one or more incentives.

3. The method of claim 2, wherein the shipping option that must be adhered to in order receive the one or more incentives includes synchronizing the delivery for the first item and the second item such that the first item and the second item are delivered to a same destination for a single delivery.

4. The method of claim 2, further comprising incrementing the one or more incentives based on the purchase of the first item and the second item.

5. The method of claim 1, further comprising generating a shipping option that must be chosen to receive one or more incentives, the shipping option includes changing a destination that the first item is delivered to from a first destination to a second destination.

6. The method of claim 1, further comprising generating a shipping option that must be chosen to receive one or more incentives, the shipping option includes changing a time period that the first item will be delivered to a destination from a first time period to a second time period.

7. The method of claim 1, wherein the one or more incentives include at least one incentive of a group of incentives consisting of: a reduction in price to ship the first item, free return policy for the first item, and rewards points.

8. The method of claim 1, wherein the learning, via a machine learning model, preferences based on the user input includes one or more of: learning a day of week that the user has historically shipped on, a shipping destination location that the user has historically shipped an item to, a service level that the user has historically used, and package dimensions of packages that the user has historically shipped.

9. The method of claim 1, further comprising presenting, at the web page or app page and based on communicating with a social media server, one or more events associated with an acquaintance of the user.

10. A system comprising:
one or more processors; and
one or more computer storage media storing computer-useable instructions that, when used by the one or more processors, causes the one or more processors to perform a method, the method comprising:
receiving user input that indicates one or more shipment selections made by one or more users for a plurality of shipments;
storing, in computer memory, the user input;
learning, via a machine learning model, preferences based on the user input;
based at least in part on the learning, causing presentation, at a web page or app page of the computer device, of a first option to ship a first item or a second option to earn one or more incentives for a particular user.

11. The system of claim 10, the method further comprising:
generating a shipping option to ship the first item; and
presenting, based at least in part on the learning, via the machine learning model, a second item to the computing device and presenting an indication that the second item can be purchased contingent upon adhering to the shipping option in order to receive one or more incentives.

12. The system of claim 11, wherein the shipping option that must be adhered to in order receive the one or more incentives includes synchronizing a delivery for the first item and the second item such that the first item and the second item are delivered to a same destination for a single delivery.

13. The system of claim 11, the method further comprising incrementing the one or more incentives based on the purchase of the first item and the second item.

14. The system of claim 19, the method further comprising generating a shipping option that must be chosen to receive one or more incentives, the shipping option includes changing a destination that the first item is delivered to from a first destination to a second destination.

15. The system of claim 10, the method further comprising generating a shipping option that must be chosen to receive one or more incentives, the shipping option includes changing a time period that the first item will be delivered to a destination from a first time period to a second time period.

16. The system of claim 15, wherein the causing presentation, at the web page or app page of the computer device, of a first option to ship a first item or a second option to earn one or more incentives for a particular user occurs via a logistic entity's API that is embedded into a web application of an electronic marketplace checkout functionality, and wherein the first option or second option is provided in response to a selection of the first item via the checkout functionality.

17. The method of claim 1, wherein the web page or app page corresponds to one or more servers of logistics entity and does not correspond to an electronic marketplace or retailer.

18. The method of claim 1, wherein the causing presentation occurs on the app page and not the web page, and wherein one or more portions of the app page corresponds to an extension or plugin that is associated with data locally installed on the computing device.

19. A computer storage media having computer-executable instructions embodied thereon that, when executed, by a processor, causes the processor to perform a method, the method comprising:
receiving shipping data associated with historical shipments of one or more users and a logistics entity;
storing, in computer memory, the shipping data;
learning, via a machine learning model, preferences based on the shipping data;
based at least in part on the learning, causing presentation, at a web page or app page of a computing device, of a first option to ship an item.

20. The computer storage media of claim 15, the method further comprising generating a shipping option that must be chosen to receive one or more incentives, the shipping option includes changing a destination that the item is delivered to from a destination address to an access point.
